(19) United States
(12) Patent Application Publication
(10) Pub. No.: US 2024/0160188 A1
(43) Pub. Date: May 16, 2024

(54) INFORMATION PROCESSING METHOD, STORAGE MEDIUM, INFORMATION PROCESSING APPARATUS, DESIGNING METHOD OF MOLD, MANUFACTURING METHOD OF MOLD, AND MANUFACTURING METHOD OF MOLDED PRODUCT

(71) Applicant: CANON KABUSHIKI KAISHA, Tokyo (JP)

(72) Inventors: YUICHI MATSUMI, Kanagawa (JP); MUNETO NAGATOMO, Tokyo (JP); HIDEKI WATANABE, Kanagawa (JP)

(21) Appl. No.: 18/503,522

(22) Filed: Nov. 7, 2023

(30) Foreign Application Priority Data
Nov. 15, 2022 (JP) 2022-182673
Nov. 15, 2022 (JP) 2022-182674

(51) Int. Cl. G05B 19/418

(52) U.S. Cl. CPC G05B 19/41835; G05B 2219/35044

(57) ABSTRACT

An information processing method of designing a mold for molding a molded product, the method includes a processing of receiving data including a molded product area indicating a three-dimensional shape of the molded product, and a non-molded product area indicating a three-dimensional shape of a non-molded product space enclosing the molded product, and a processing of extracting, from the non-molded product area, a three-dimensional space that becomes an undercut portion in a state where a first mold and a second mold forming the molded product are opened.

### BACKGROUND OF THE INVENTION

### Field of the Invention

The present invention relates, for example, to an information processing method for designing a mold efficiently.

### Description of the Related Art

Hitherto, in designing a molded product manufactured using a mold, there is a need to design the mold while considering an undercut shape, which is a shape that cannot be molded by moving the mold only in a mold opening direction. A generally known method for forming an undercut shape is a method using a slide mold that is moved in a sliding direction, which is a lateral direction with respect to the mold opening direction, along an inclination of an angular pin while opening the mold. Generally, a proficient knowledge regarding mold design is required to confirm the area of the undercut shape and to determine whether the undercut shape is moldable using a slide mold. Therefore, depending on the proficiency level of the designer, an unintended undercut shape or a non-moldable undercut shape may be formed.

Japanese Patent Application Laid-Open Publication No. 2011-88432 proposes a method for determining a surface of a molded product that is non-moldable due to the mold being impossible to draw out, as a technique that enables the undercut shape to be recognized in advance. Specifically, regarding each of the surfaces constituting a three-dimensional shape of a molded product, a normal line is extended from a point on a surface, and whether the normal line includes an opposite-direction component as a mold opening direction of a mold is determined. When the normal line includes an opposite-direction component that is opposite to the mold opening direction, if both the straight line that extends in the mold opening direction from a surface having the point from which the normal line extends and a straight line extending in an opposite direction from the mold opening direction reach another surface, the surface is extracted as constituting an undercut shape.

Further, as a designing method of a mold, a conventional method is known in which a parting line is set on a surface of a three-dimensional shape data of a molded product, and a parting surface, i.e., dividing boundary surface, of the mold is set based on the parting line. Further, in designing a molded product manufactured using a mold, it is necessary to design the mold while considering an undercut shape of the mold, which is the shape that cannot be molded by moving the mold in the mold opening direction. As a method for molding the undercut shape, a generally known method utilizes a slide core that moves in a sliding direction, which is a lateral direction with respect to a mold opening direction along an inclination of an angular pin, in correspondence with a mold opening operation of the mold. When molding the undercut portion using a slide core, a quality of the molded product and a manufacturing cost of the mold are affected by which area of the product other than the undercut portion is formed using the slide core.

Japanese Patent Application Laid-Open Publication No. 2013-63623 discloses a technique of extracting a moldable surface using a slide core for molding an undercut shape. Specifically, which surface that is adjacent to an undercut shape having a specific shape, such as a cylindrical shape, is movable using a slide core is determined, and when it is determined that the surface is moldable, the surface adjacent to the undercut shape is extracted as a surface moldable using the slide core.

### SUMMARY OF THE INVENTION

According to a first aspect of the present invention, an information processing method of designing a mold for molding a molded product, the method includes a processing of receiving data including a molded product area indicating a three-dimensional shape of the molded product, and a non-molded product area indicating a three-dimensional shape of a non-molded product space enclosing the molded product, and a processing of extracting, from the non-molded product area, a three-dimensional space that becomes an undercut portion in a state where a first mold and a second mold forming the molded product are opened.

According to a second aspect of the present invention, an information processing method includes a processing of extracting a plurality of undercut portions becoming an undercut when opening a first mold and a second mold to form a molded product, a processing of setting, for each of the plurality of undercut portions, a sliding direction of a slide mold arranged in the undercut portion, a processing of extracting, among the plurality of undercut portions, at least two undercut portions in which a single slide mold is arranged, and a processing of extracting a surface that may be molded by the single slide mold and that includes an area that does not adjoin any one of the plurality of undercut portions.

Further features of the present invention will become apparent from the following description of exemplary embodiments with reference to the attached drawings.

### BRIEF DESCRIPTION OF THE DRAWINGS

FIG. 1 is a schematic diagram illustrating a hardware configuration of an information processing apparatus according to a first embodiment.

FIG. 2 is a flowchart illustrating a processing flow of an information processing method according to the first embodiment.

FIG. 3 is a schematic diagram illustrating an example of a three-dimensional shape data of a molded product according to the first embodiment.

FIG. 4 is a schematic diagram illustrating a processing executed in step S4 according to the first embodiment.

FIG. 5A is a schematic diagram illustrating a processing for creating a rectangular parallelepiped space executed in step S5 according to the first embodiment.

FIG. 5B is a schematic diagram illustrating a processing for dividing a rectangular parallelepiped space into evenly spaced polyhedrons executed in step S5.

FIG. 5C is a schematic diagram illustrating a processing for dividing the rectangular parallelepiped space into evenly spaced points as a modified example of the process executed in step S5.

FIG. 6 is a schematic diagram illustrating a processing executed in step S6 according to the first embodiment.

FIG. 7A is a schematic diagram illustrating a processing executed in step S7 according to the first embodiment.

FIG. 7B is a table showing a result of execution of the processing of step S7.

FIG. 7C is a table showing the result of execution of the processing of step S7.

FIG. 7D is a table showing the result of execution of the processing of S7.

FIG. 7E is a table showing the result of execution of the processing of S7.

FIG. 8A is a schematic diagram illustrating a processing executed in step S8 according to the first embodiment.

FIG. 8B is a schematic diagram illustrating the processing executed in step S8 according to the first embodiment.

FIG. 9A is a schematic diagram illustrating a processing executed in step S9 according to the first embodiment.

FIG. 9B is a schematic diagram illustrating the processing executed in step S9 according to the first embodiment.

FIG. 9C is a schematic diagram illustrating the processing executed in step S9 according to the first embodiment.

FIG. 10 is a schematic diagram illustrating a processing executed in step S10 according to the first embodiment.

FIG. 11 is a flowchart illustrating a processing flow illustrating an information processing method according to a second embodiment.

FIG. 12 is a schematic diagram illustrating one example of a three-dimensional shape data of a molded product according to the second embodiment.

FIG. 13A is a schematic diagram illustrating a processing executed in steps S4 and S21 according to the second embodiment.

FIG. 13B is a schematic diagram illustrating the processing executed in steps S4 and S21 according to the second embodiment.

FIG. 13C is a schematic diagram illustrating the processing executed in steps S4 and S21 according to the second embodiment.

FIG. 14A is a schematic diagram illustrating the processing executed in steps S4 to S9 according to the second embodiment.

FIG. 14B is a schematic diagram illustrating the processing executed in steps S4 to S9 according to the second embodiment.

FIG. 14C is a schematic diagram illustrating the processing executed in steps S4 to S9 according to the second embodiment.

FIG. 15 is a table illustrating a processing executed in step S23 according to the second embodiment.

FIG. 16 is a schematic diagram illustrating a processing executed in step S6 according to another embodiment.

FIG. 17 is a flowchart illustrating a processing flow of an information processing method according to a third embodiment.

FIG. 18 is a flowchart illustrating a processing executed in step S36.

FIG. 19A is a perspective view illustrating a processing executed in steps S51 to S54.

FIG. 19B is a top view illustrating the processing executed in steps S51 to S54.

FIG. 20A is a perspective view illustrating the processing executed in steps S51 to S54.

FIG. 20B is a top view illustrating the processing executed in steps S51 to S54.

FIG. 21 is a flowchart illustrating a processing executed in step S55.

FIG. 22A is a perspective view illustrating the processing executed in step S55.

FIG. 22B is a cross-sectional view illustrating the processing executed in step S55.

FIG. 23A is a schematic diagram illustrating a processing executed in steps S62 and S63.

FIG. 23B is a schematic diagram illustrating a processing executed in steps S65 to S68.

FIG. 23C is a schematic diagram illustrating a processing executed in steps S65 to S68 that is executed by returning from a processing of step S69.

FIG. 24 is a schematic diagram illustrating the processing executed in step S37.

### DESCRIPTION OF THE EMBODIMENTS

According to the method disclosed in Japanese Patent Application Laid-Open Publication No. 2011-88432, extraction of an undercut shape is performed in units of surfaces from a three-dimensional shape of a molded product. Therefore, if a part of a surface is extracted as being a surface constituting an undercut shape, it is difficult to judge the extent of the surface constituting the undercut shape, such that is difficult to design the mold efficiently.

### First Embodiment

Now, embodiments for executing the present technique will be described in detail with reference to the drawings. The configurations illustrated below are merely examples, and those skilled in the art may change the details of the configurations arbitrarily without deviating from the scope of the invention. Further numerical values in the description are reference values, and they are merely examples.

### Apparatus Configuration

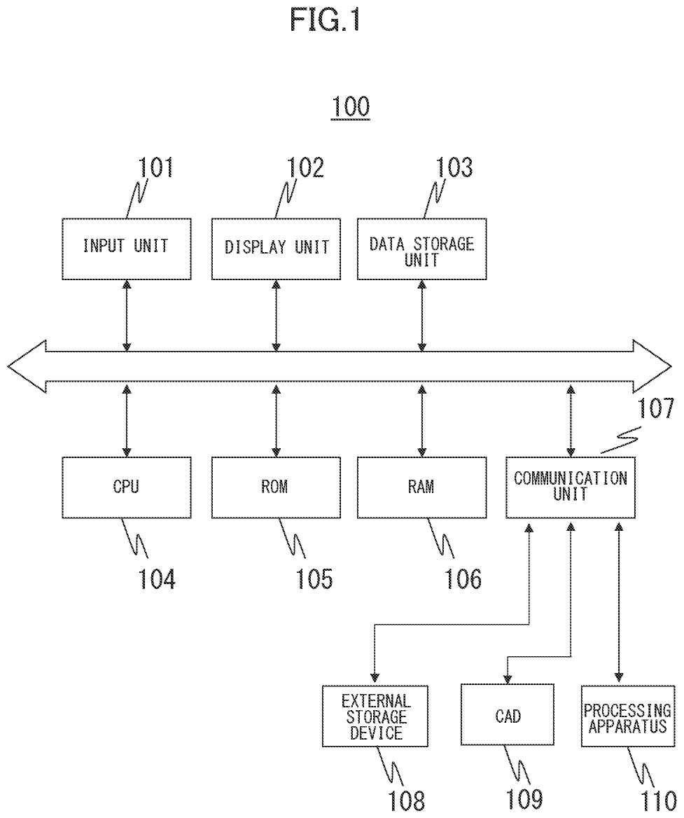

FIG. 1 is a schematic diagram illustrating a hardware configuration of an information processing apparatus according to a first embodiment. An information processing apparatus 100 includes an input unit 101, a display unit 102, a data storage unit 103, a CPU 104, a ROM 105, a RAM 106, and a communication unit 107, wherein the respective components are mutually connected in a communicatable manner through a bus.

The input unit 101 is a device through which an operator enters instructions and data, and for example, it may include pointing systems such as a keyboard or a mouse, or a voice input device. The display unit 102 is a display device that displays a graphical user interface (GUI), for example, and display devices such as a liquid crystal display, an OLED, or a CRT may be used. The input unit 101 and the display unit 102 may be composed of an input/output integrated touch panel. The data storage unit 103 is a device that stores various data and programs including a molded product shape data, and it is composed of a storage device such as a hard disk that is capable of reading and writing data.

The CPU 104 is a computer, i.e., information processing unit, that performs various processing by cooperating with respective components. The ROM 105 and the RAM 106 provide control programs, data, and work area that are necessary for the processing to the CPU 104. In a case where the control program necessary for the processing is stored in the data storage unit 103 or the ROM 105, the control program is temporarily read into the RAM 106 before being executed. In another example, if a processing program is loaded from an exterior via the communication unit 107, the processing program is either stored in the data storage unit 103 before being read into the RAM 106 or directly read into the RAM 106 from the communication unit 107 and executed.

The communication unit 107 is an interface (I/F) through which the information processing apparatus 100 communicates with an external network such as an external apparatus or the Internet. Wireless or wired communication apparatuses conforming to known communication systems such as the Ethernet, USB, IEEE, and Bluetooth (Registered Trademark) may be used. In FIG. 1, an external storage device 108, a CAD 109, and a processing apparatus 110 are illustrated as an example of the external apparatuses, but the connection destination of the communication unit 107 is not limited thereto.

The information processing apparatus 100 according to the first embodiment may also be equipped with various components other than the above-described components.

### Information Processing Method

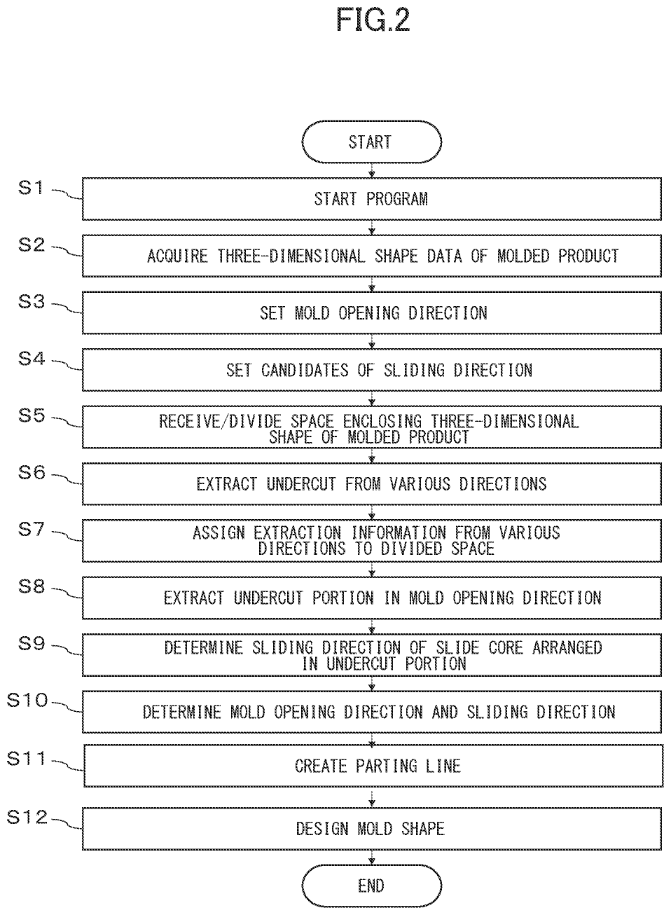

A procedure of the information processing method according to the first embodiment will be described with reference to the flowchart of FIG. 2.

### Step S1

In step S1, when a start instruction from an operator is received through the input unit 101 by the information processing apparatus 100, the CPU 104 reads a mold generation processing program stored in the ROM 105 and starts the execution.

### Step S2

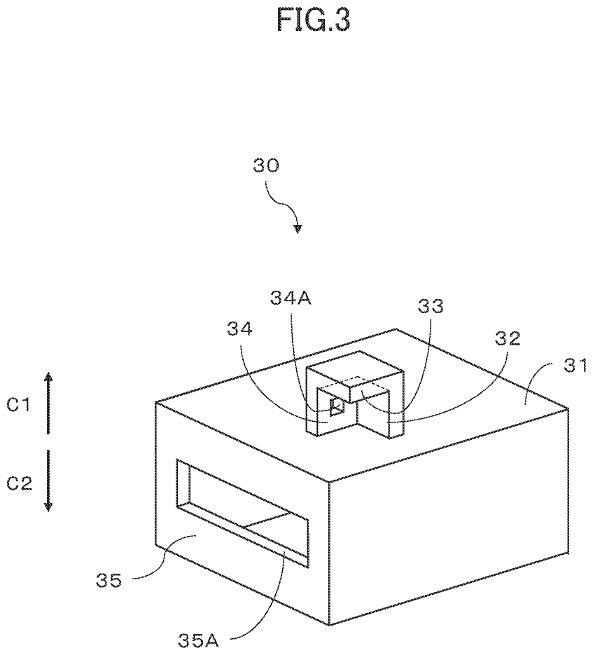

In step S2, the CPU 104 prepares a three-dimensional shape data of a molded product that the mold is designed to produce. In the present example, it is assumed that a three-dimensional shape data 30 of a molded product whose shape is illustrated in FIG. 3 is prepared.

As illustrated in FIG. 3, the three-dimensional shape data 30 is data corresponding to a molded product area that corresponds to a three-dimensional shape of a molded product. The three-dimensional shape data 30 has a shape that includes surfaces 32 and 34 that extend upward from a surface 31, and a surface 33 that is connected to the surfaces 32 and 34 and that is opposed to the surface 31. Further, the three-dimensional shape data 30 has a shape that includes a surface 35 that extends downward in the drawing from the surface 31. The surface 34 has a quadrangular hole-shaped hole 34A formed thereto, and the surface 35 has a quadrangular hole-shaped hole 35A formed thereto.

If the three-dimensional shape data 30 is already stored in the data storage unit 103, the operator designates the data and receives the data through the input unit 101. Further, if the three-dimensional shape data 30 is not yet entered to the information processing apparatus 100, the operator instructs through the input unit 105 to acquire the data from a location where the data is stored, such as the CAD 109 or the external storage device 108, through the communication unit 107. When the three-dimensional shape data 30 is prepared, the CPU 104 causes the display unit 102 to display a 3-D model illustrated in FIG. 3, for example.

### Step S3

In step S3, the operator enters, i.e., sets, a mold opening direction. The operator refers to the three-dimensional shape data 30, i.e., 3-D model, displayed on the display unit 102, and as illustrated in FIG. 3, enters, or sets, mold opening directions C1 and C2 for opening the cavity mold and the core mold through the input unit 101. Information regarding the mold opening directions C1 and C2 being set is stored in the data storage unit 103 by the CPU 104. Methods for setting the mold opening direction include, for example, a method for designating a vector of the mold opening direction, and a method for selecting an arbitrary outer surface and setting a normal line vector of the selected surface as the mold opening direction. Further, the methods may include a method for setting a direction parallel to an arbitrary edge of an outer surface of the molded product as a mold opening direction, or a method for estimating a vector of the mold opening direction from three-dimensional shape data of the molded product, but are not limited thereto.

While performing the processing of step S3, the CPU 104 may display the image illustrated in FIG. 3 on the display unit 102, for example.

### Step S4

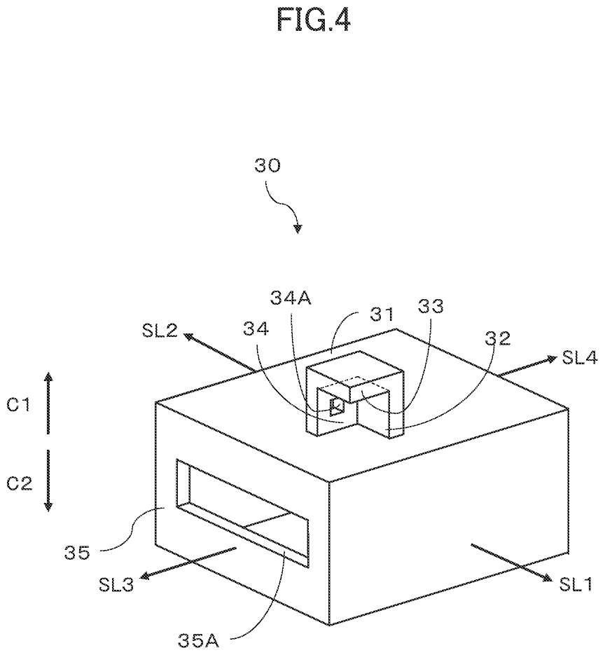

In step S4, the CPU 104 sets candidates of a sliding direction which is a direction that differs from the mold opening directions C1 and C2 set in step S3 and is for sliding the slide mold when removing the slide mold forming the undercut shape from the molded product. The slide mold may also be referred to as a slide core. The sliding directions SL1 to SL4 which are candidates of the sliding direction being set is stored by the CPU 104 in the data storage unit 103. As a method for setting the candidates of the sliding direction, for example, at first, the CPU 104 reads the three-dimensional shape data 30 of the molded product and the mold opening directions C1 and C2 from the data storage unit 103. Then, the CPU 104 computes normal line directions of the respective flat surfaces and axial directions of the respective cylindrical, conical, and annular surfaces in the three-dimensional shape data 30 of the molded product, and as illustrated in FIG. 4, sets the directions vertical to the mold opening directions C1 and C2 as the sliding directions SL1 to SL4. Other methods may include a method of setting direction +X, direction −X, direction +Y, and direction −Y as candidates of the sliding direction when the mold opening direction is set to direction +Z and direction −Z, or a method for selecting the vector being the candidate of the sliding direction, but the method is not limited thereto.

### Step S5

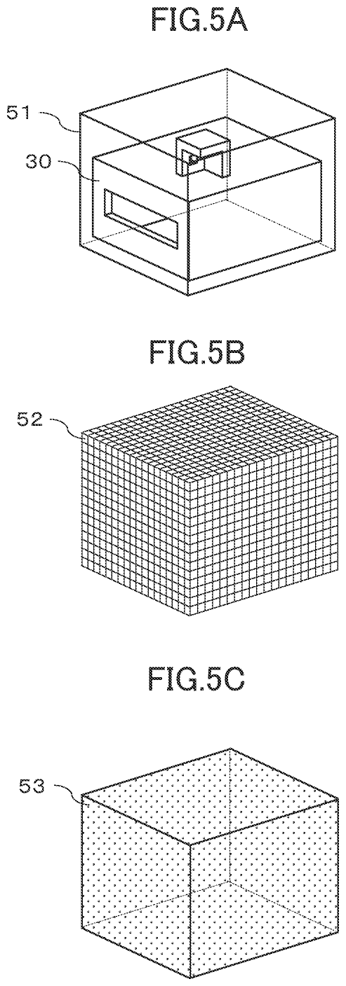

In step S5, the CPU 104 computes a rectangular parallelepiped, i.e., bounding box, enclosing the three-dimensional shape data 30 of the molded product. At first, the CPU 104 receives a data of a three-dimensional space that includes the three-dimensional shape data 30 serving as the molded product area indicating the three-dimensional shape, that is, a non-molded product space that encloses the three-dimensional shape data 30, from a location storing the data. Next, as illustrated in FIG. 5A, the CPU 104 creates a rectangular parallelepiped space 51 of a size greater than the three-dimensional shape data 30 within the three-dimensional space including the three-dimensional shape data 30 of the molded product, and arranges the three-dimensional shape data 30 such that the entire data is contained within the rectangular parallelepiped space 51. In other words, the CPU 104 is designed to receive data including the rectangular parallelepiped space 51 that serves as a non-molded product area indicating the three-dimensional shape of the non-molded product space enclosing the three-dimensional shape data 30.

Next, the CPU 104 divides the rectangular parallelepiped space 51 so as to facilitate various calculations being performed in the subsequent processes. Methods for dividing the rectangular parallelepiped space 51 may include a method of setting the rectangular parallelepiped space 51 as an assembly of polyhedrons 52 that divide the rectangular parallelepiped space 51 into even spaces as illustrated in FIG. 5B. The polyhedrons 52 according to the first embodiment are each a cube, but are not limited thereto. One type of pattern capable of periodically filling up a three-dimensional space, that is, a single polyhedron that can fill up a three-dimensional space by simply moving in parallel directions, may include, in addition to cubes, a regular hexagonal prism, a rhombic dodecahedron, an elongated rhombic dodecahedron, and a truncated octahedron. Further, it may be a polyhedron that may fill up a three-dimensional space through rotational movement. The polyhedron 52 may be a rectangular parallelepiped, or a prism such as a triangular prism, or a pyramid such as a quadrangular pyramid. Other methods include, as illustrated in FIG. 5C, a method of generating evenly spaced points within the rectangular parallelepiped space 51 and forming an assembly of a plurality of points 53. According to these methods, it is preferable to set the distance of dividing the space into polyhedrons 52 or the distance of generating points to be equal to or shorter than a length of a shortest edge of the three-dimensional shape data 30, for example. The method for dividing the rectangular parallelepiped space 51 is not limited to these methods. In the following description, a method for dividing the rectangular parallelepiped space 51 into an assembly of polyhedrons 52 will be illustrated as an example.

Each of the rectangular parallelepiped space 51 and the polyhedrons 52 are stored in the data storage unit 103 by the CPU 104.

This processing of step S5 constitutes a process of receiving data including the molded product data, i.e., three-dimensional shape data 30, of the molded product and the non-molded product area, i.e., rectangular parallelepiped space 51, indicating the three-dimensional shape of the non-molded product space enclosing the molded product.

### Step S6

In step S6, the CPU 104 extracts a portion being the undercut of the three-dimensional shape data 30 when opening the mold in respective directions of the mold opening directions C1 and C2 and the sliding directions SL1 to SL4. The CPU 104 reads the three-dimensional shape data 30 and various data of the mold opening directions C1 and C2, the sliding directions SL1 to SL4, the rectangular parallelepiped space 51, and the polyhedron 52 from the data storage unit 103. When opening the mold in various directions of the mold opening directions C1 and C2 and the sliding directions SL1 to SL4, the CPU 104 computes the polyhedrons 52 that are positioned at the location of an undercut of the three-dimensional shape data 30.

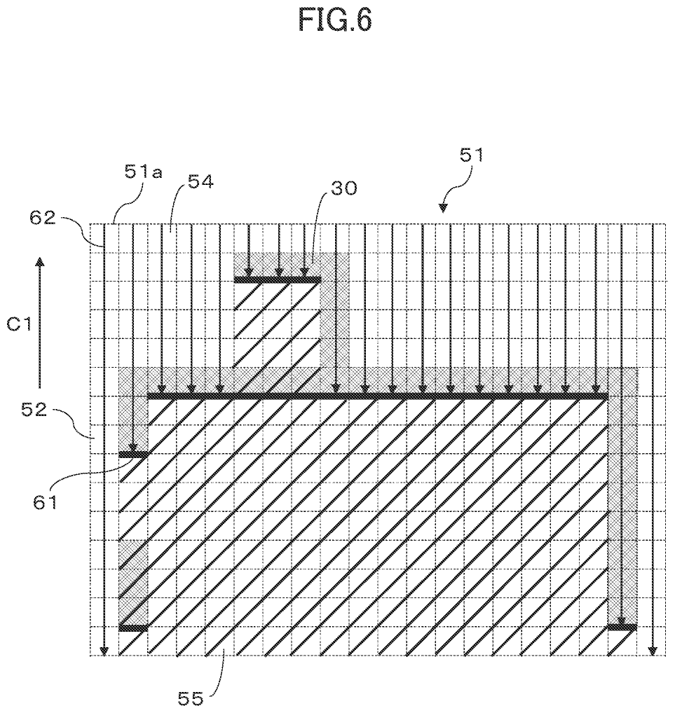

FIG. 6 illustrates a case of computing the polyhedrons 52 that are positioned at the area of the undercut of the three-dimensional shape data 30 when opening the cavity mold in a mold opening direction C1 serving as a first direction. As illustrated in FIG. 6, at first, the CPU 104 draws a rear surface 61 of the three-dimensional shape data 30 in the mold opening direction C1. Next, the CPU 104 extends a straight line 62 that passes through a center of the polyhedron 52 from a downstream end 51a of the rectangular parallelepiped space 51 in the mold opening direction C1 toward an upstream direction of the mold opening direction C1, and acquires a length to the rear surface 61 that the straight line 62 first reaches. Then, the CPU 104 determines that the polyhedron 52 positioned upstream in the mold opening direction C1 of the rear surface 61 is positioned at the area becoming the undercut of the three-dimensional shape data 30 when opening the cavity mold in the mold opening direction C1.

In other words, the CPU 104 computes the polyhedron 52 that is determined to be positioned in a downstream-side space 54 downstream of the rear surface 61 of the three-dimensional shape data 30 and the polyhedron 52 determined to be positioned in an upstream-side space 55 upstream of the rear surface 61 in the mold opening direction C1. Then, the CPU 104 determines that the polyhedron 52 positioned in the downstream-side space 54 is not an undercut in the corresponding direction, and determines that the polyhedron 52 positioned at the upstream-side space 55 is an undercut in the corresponding direction.

The rear surface 61 constitutes a boundary portion switching from the three-dimensional shape data 30 to the rectangular parallelepiped space 51 in a direction opposed to the mold opening direction C1, and the polyhedrons 52 positioned in the upstream-side space 55 constitute the area from the upstream end of the rectangular parallelepiped space 51 to the rear surface 61.

Similarly, when opening the mold in the respective directions of the mold opening direction C2 and the sliding directions SL1 to SL4, the CPU 104 determines that the polyhedron 52 determined to be positioned in the downstream-side space 54 in the corresponding direction is not an undercut in the corresponding direction. Further, the CPU 104 determines that the polyhedron 52 positioned at the upstream-side space 55 in the corresponding direction is an undercut in the corresponding direction.

As described, the CPU 104 is configured to divide the rectangular parallelepiped space 51 into evenly spaced polyhedrons 52 and to determine whether each polyhedron 52 is an undercut. Thereby, when computing an area serving as an undercut portion when opening the cavity mold and the core mold in the mold opening directions, the information processing apparatus 100 determines the same for each polyhedron 52, according to which the load of the processing can be reduced, and the position of the undercut portion can be specified accurately.

Further, by determining the polyhedron 52 being the undercut for each direction by the processing of step S6, the information processing apparatus 100 may be able to set the undercut information accurately by a simple processing that does not affect the shape of the molded product.

The information of the polyhedrons 52 determined to be positioned in the downstream-side space 54 and the information of the polyhedrons 52 determined to be positioned in the upstream-side space 55 are stored in the data storage unit 103 by the CPU 104.

Further, in the example illustrated in FIG. 6, the rectangular parallelepiped space 51 is divided into evenly spaced polyhedrons 52, but even if the rectangular parallelepiped space 51 is divided into evenly spaced points, the CPU 104 executes a similar processing. Specifically, the CPU 104 executes a processing of extending a straight line that passes through the evenly spaced point in the rectangular parallelepiped space 51 instead of the process of extending the straight line 62 that passes through the center of the polyhedron 52 in step S6.

That is, when computing the area of the undercut portion in the state where the cavity mold and the core mold are opened in the mold opening directions, the information processing apparatus 100 determines the rectangular parallelepiped space 51 for each of the points that are evenly spaced and dividing the rectangular parallelepiped space 51. Thereby, the information processing apparatus 100 may reduce the load of the processing and to specify the position of the undercut portions accurately.

### Step S7

In step S7, the CPU 104 assigns information, i.e., extraction information, extracting whether each of the plurality of polyhedrons 52 that divide the rectangular parallelepiped space 51 into even spaces enclosing the three-dimensional shape data 30 of the molded product is an undercut in the respective directions. The CPU 104 reads the three-dimensional shape data 30 and the various data of the mold opening directions C1 and C2, the sliding directions SL1 to SL4, the rectangular parallelepiped space 51, and the polyhedron 52 from the data storage unit 103. Further, the CPU 104 reads the respective data of the downstream-side space 54 determined to be positioned downstream of the rear surface 61 of the three-dimensional shape data 30 and the upstream-side space 55 determined to be positioned upstream thereof from the data storage unit 103. The CPU 104 assigns an extraction information indicating that the polyhedron 52 is not an undercut in the corresponding direction for the polyhedron 52 determined to be positioned in the downstream-side space 54. Further, the CPU 104 assigns an extraction information indicating that the polyhedron 52 is an undercut in the corresponding direction for the polyhedron 52 that is determined to be positioned in the upstream-side space 55.

The extraction information assigned to each polyhedron 52 is stored in the data storage unit 103 by the CPU 104.

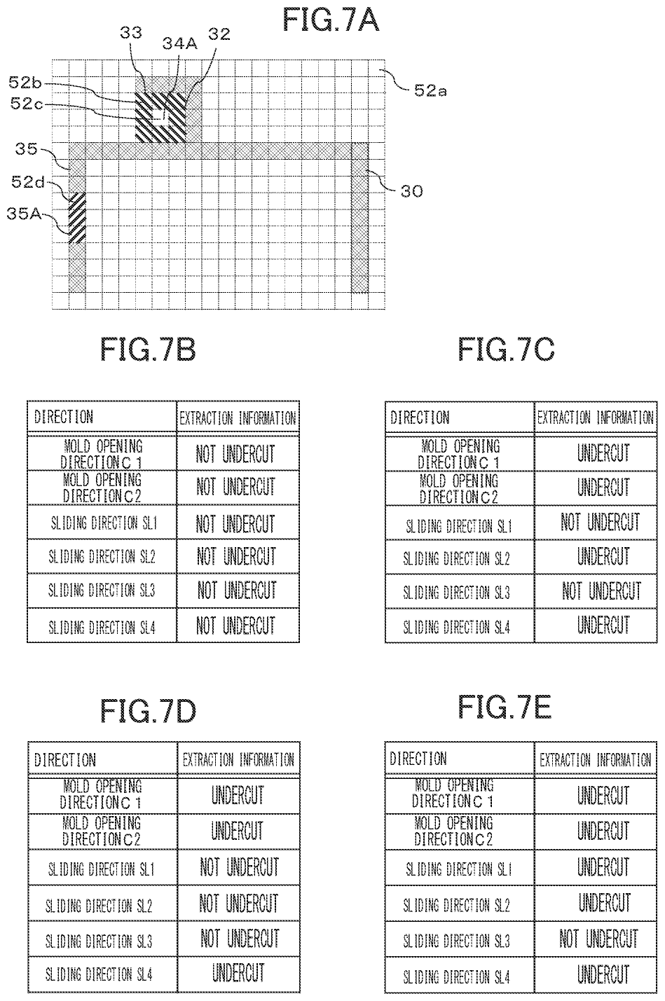

FIG. 7A is a cross-sectional view of the three-dimensional shape data 30 in the mold opening direction C1, and FIG. 7B is a table illustrating the extraction information assigned to polyhedrons 52a illustrated in FIG. 7A. As illustrated in FIG. 7B, extraction information that it is not an undercut in each of the directions of the mold opening directions C1 and C2 and the sliding directions SL1 to SL4 is assigned to the polyhedrons 52a.

FIG. 7C is a table illustrating the extraction information assigned to polyhedrons 52b surrounded by surfaces 32, 33, and 34. As illustrated in FIG. 7C, extraction information indicating that the polyhedron 52b is an undercut in each of the mold opening directions C1 and C2 and the sliding directions SL2 and SL4 is assigned to the polyhedrons 52b. Further, extraction information indicating that the polyhedron 52b is not an undercut in each of the sliding directions SL1 and SL3 is assigned to the polyhedrons 52b.

FIG. 7D is a table illustrating the extraction information assigned to a polyhedron 52c positioned in the hole 34A formed on the surface 34. As illustrated in FIG. 7D, extraction information indicating that the polyhedron 52c is an undercut in each of the mold opening directions C1 and C2 and the sliding direction SL4 is assigned to the polyhedron 52c. Further, extraction information indicating that the polyhedron 52c is not an undercut in each of the sliding directions SL1 to SL3 is assigned to the polyhedron 52c.

FIG. 7E is a table illustrating the extraction information assigned to polyhedrons 52d positioned in the hole 35A formed on the surface 35. As illustrated in FIG. 7E, extraction information indicating that the polyhedron 52d is an undercut in each of the mold opening directions C1 and C2 and the sliding directions SL1, SL2, and SL4 is assigned to the polyhedrons 52d. Further, extraction information indicating that the polyhedron 52d is not an undercut in the sliding direction SL3 is assigned to the polyhedrons 52d.

As described, the CPU 104 assigns, or sets, the extraction information that the polyhedron 52 is an undercut for the polyhedrons 52 that are arranged in the area sandwiched by the three-dimensional shape data 30 in the mold opening directions C1 and C2. Thereby, the information processing apparatus 100 may set an appropriate extraction information for the area being the undercut when opening the cavity mold and the core mold in the mold opening directions C1 and C2. The processing of step S7 constitutes an information setting processing in the first embodiment, and information extracted as being an “undercut” among the extraction information constitutes an undercut information in the first embodiment.

### Step S8

In step S8, the CPU 104 extracts an area being an undercut when opening the cavity mold and the core mold in the mold opening directions C1 and C2. The CPU 104 reads the three-dimensional shape data 30 and the respective data of the mold opening directions C1 and C2, the sliding directions SL1 to SL4, the rectangular parallelepiped space 51, and the polyhedron 52 from the data storage unit 103. Further, the CPU 104 reads the respective data of the downstream-side space 54 that is determined to be positioned downstream of the rear surface 61 of the three-dimensional shape data 30 regarding the respective directions and the upstream-side space 55 that is determined to be positioned upstream thereof from the data storage unit 103. Then, the CPU 104 reads the extraction information assigned to each of the polyhedrons 52 from the data storage unit 103.

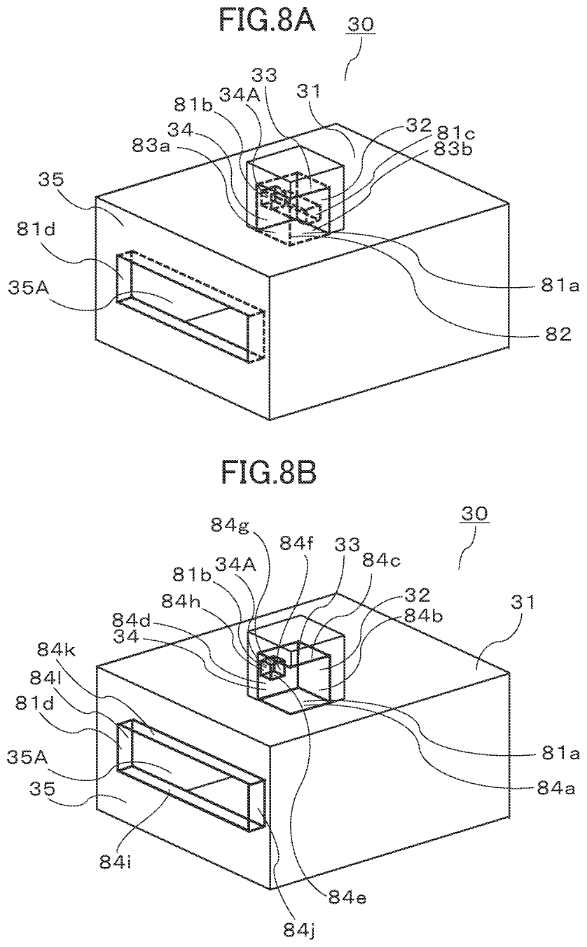

FIG. 8A is a view illustrating a state in which an area serving as an undercut portion in the mold opening directions C1 and C2 is extracted by the CPU 104. As illustrated in FIG. 8A, the CPU 104 extracts, among the polyhedrons 52 included in the three-dimensional space surrounded by surfaces 32 to 34, the polyhedrons 52 excluding the polyhedrons 52 opposed to the hole 34A in the sliding directions SL1 and SL2 as an undercut portion 81a. Further, the CPU 104 extracts the polyhedrons 52 included in the three-dimensional space surrounded by the hole 34A formed on the surface 34 as an undercut portion 81b. Further, the CPU 104 extracts, among the polyhedrons 52 included in the three-dimensional space surrounded by surfaces 32 to 34, the polyhedrons 52 that are opposed to the hole 34A in the sliding directions SL1 and SL2 as an undercut portion 81c. Then, the CPU 104 extracts the polyhedrons 52 that are included in the three-dimensional space surrounded by the hole 35A formed on the surface 35 as an undercut portion 81d.

The CPU 104 may display an image illustrating the undercut portions 81a to 81d of the three-dimensional space extracted by the processing of step S8 on the display unit 102.

As described, in the information processing apparatus 100 according to the first embodiment, undercut portions 81d and 81e when opening the cavity mold and the core mold for forming the molded product are extracted from the three-dimensional shape data 30 and the rectangular parallelepiped space 51. Then, the information processing apparatus 100 may display the areas corresponding to the extracted undercut portions 81d and 81e on the display unit 102, and by displaying the same on the display unit 102, the undercut portions 81d and 81e may be visually recognized in the three-dimensional space by the operator. Thereby, the information processing apparatus 100 may enable the operator to recognize the undercut shape easily.

The processing of S8 constitutes a processing of executing, among the non-molded product area, a three-dimensional shape constituting the undercut portion when opening a first mold and a second mold for molding the molded product.

Further, when displaying the undercut portions 81a to 81d as three-dimensional space, the CPU 104 extracts lines, i.e., boundary lines, and surfaces, i.e., boundary surfaces, serving as boundaries between the rectangular parallelepiped space 51 and the undercut portions 81a to 81d, and displays the same on the display unit 102. In the example illustrated in FIG. 8A, the CPU 104 extracts a boundary line 82a and boundary surfaces 83a and 83b serving as boundary between the rectangular parallelepiped space 51 and the undercut portion 81a, and displays the same on the display unit 102. The CPU 104 similarly extracts a boundary surface serving as boundary between the rectangular parallelepiped space 51 and the undercut portion 81b or the boundary surface serving as boundary between the rectangular parallelepiped space 51 and the undercut portion 81d, and displays the same on the display unit 102.

As described, the information processing apparatus 100 according to the first embodiment extracts the boundary line 82a and the boundary surfaces 83a and 83b of the undercut portions 81d and 81e, and displays the same on the display unit 102. Thereby, the information processing apparatus 100 may easily enhance the visual recognition property of lines and surfaces serving as boundaries of the undercut portions 81d and 81e being extracted in the three-dimensional space, and enables the operator to easily distinguish the undercut shape.

Moreover, the CPU 104 extracts a surface where the undercut portions 81a to 81d and the three-dimensional shape data 30 adjoin as an undercut surface, i.e., undercut portion. As illustrated in FIG. 8B, the CPU 104 extracts a surface where the surface 31 of the three-dimensional shape data 30 and the undercut portion 81a adjoin as an undercut surface 84a, and a surface where the surface 32 and the undercut portion 81a adjoin as an undercut surface 84b. Further, the CPU 104 extracts a surface where the surface 33 and the undercut portion 81a adjoin as an undercut surface 84c, and a surface where the surface 34 and the undercut portion 81a adjoin as an undercut surface 84d. Further, the CPU 104 extracts four surfaces where the hole 34A having a quadrangular hole shape formed on the surface 34 and an undercut portion 82b adjoin as undercut surfaces 84e to 84h. Further, the CPU 104 extracts four surfaces where the hole 35A having a quadrangular hole shape formed on the surface 35 and an undercut portion 82c adjoin as undercut surfaces 84i to 84l. The CPU 104 displays the extracted undercut surfaces 84a to 84l on the display unit 102.

As described, the information processing apparatus 100 according to the first embodiment extracts the undercut surfaces 84a to 84l, and displays the same on the display unit 102. Thereby, the information processing apparatus 100 may improve the visual recognition property of the undercut surfaces 84a to 84l composing the undercut by the undercut portions 81d and 81e extracted in the three-dimensional space, and enables the operator to easily distinguish the undercut shape.

The information of the undercut portions 81a to 81d, the information of the boundary line 82a and the boundary surfaces 83a and 83b, and the information of the undercut surfaces 84a to 84l are stored in the data storage unit 103 by the CPU 104.

### Step S9

In step S9, the CPU 104 sets the sliding direction of the slide mold arranged in the undercut portions 81a to 81d in a state where the cavity mold and the core mold are opened in the mold opening directions C1 and C2 extracted in the processing of step S8. The CPU 104 reads the three-dimensional shape data 30 and respective data of the mold opening directions C1 and C2, the sliding directions SL1 to SL4, the rectangular parallelepiped space 51, and the polyhedron 52 from the data storage unit 103. Further, the CPU 104 reads the respective data of the downstream-side space 54 determined to be positioned downstream of the rear surface 61 of the three-dimensional shape data 30 and the upstream-side space 55 determined to be positioned upstream thereof in the respective directions from the data storage unit 103. Further, the CPU 104 reads extraction information assigned to each of the polyhedrons 52 from the data storage unit 103. Then the CPU 104 reads the information of the undercut portions 81a to 81d from the data storage unit 103.

The CPU 104 refers to extraction information assigned to the polyhedrons 52 positioned at each of the undercut portions 81a to 81d. If information indicating that it is not an undercut in any of the directions of the sliding directions SL1 to SL4 is assigned in the extraction information being referred to, the CPU 104 determines that the corresponding sliding direction is the sliding direction of the slide mold arranged in the corresponding undercut portion. Using the determined result, the CPU 104 sets one sliding direction as the sliding direction of the slide mold arranged in the undercut portion.

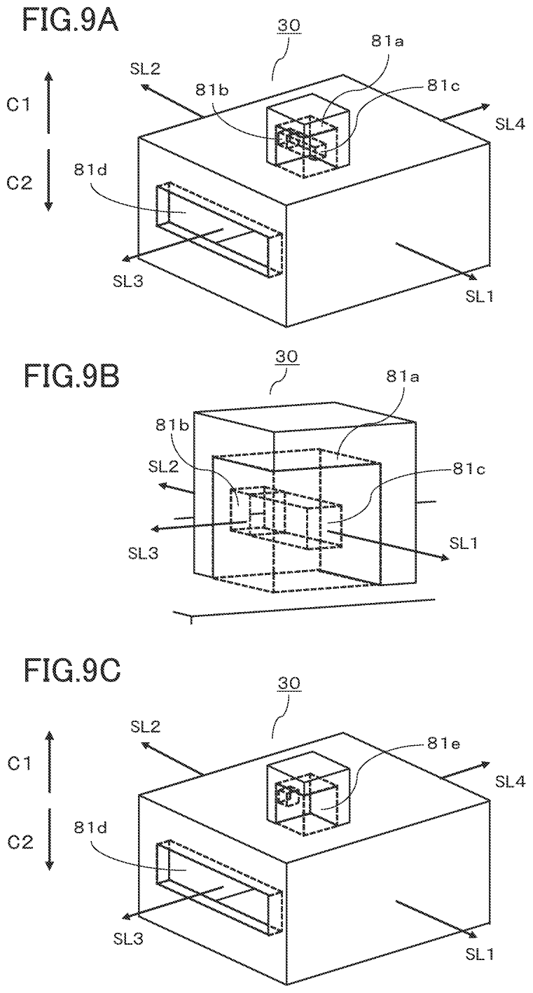

FIG. 9A is a view illustrating the extracted undercut portions 81a to 81d and the sliding directions SL1 to SL4 in the mold opening directions C1 and C2 by the CPU 104. Further, FIG. 9B is an enlarged view of the undercut portions 81a to 81c. As illustrated in FIGS. 9A and 9B, information indicating that it is not an undercut in the sliding directions SL1 and SL3 is assigned to the undercut portion 81a, since it constitutes the downstream-side space 54 in the sliding directions SL1 and SL3. Therefore, the CPU 104 determines that the slide mold arranged in the undercut portion 81a may be removed from the molded product by sliding in the sliding directions SL1 and SL3.

Information indicating that it is not an undercut in the sliding directions SL1 and SL2 is assigned to the undercut portion 81b, since it constitutes the downstream-side space 54 in the sliding directions SL1 and SL2. Therefore, the CPU 104 determines that the slide mold arranged in the undercut portion 81b may be removed from the molded product by sliding in the sliding directions SL1 and SL3.

Information indicating that it is not an undercut in the sliding directions SL1 to SL3 is assigned to the undercut portion 81c, since it constitutes the downstream-side space 54 in the sliding directions SL1 to SL3. Therefore, the CPU 104 determines that the slide mold arranged in the undercut portion 81c may be removed from the molded product by sliding in the sliding directions SL1 to SL3.

Now, as illustrated in FIGS. 9A and 9B, the undercut portions 81a to 81c are mutually adjacently arranged three-dimensional spaces. Further, the respective slide molds arranged in the undercut portions 81a to 81c have the sliding direction SL1 as a common sliding direction in which the slide mold may be removed from the molded product.

If it is determined that the plurality of slide molds arranged in a plurality of undercut portions adjacent one another has the same sliding direction set as the sliding direction capable of removing the slide molds from the molded product, the CPU 104 sets the plurality of undercut portions as an integrated undercut portion. In the example illustrated in FIGS. 9A and 9B, the CPU 104 sets the undercut portions 81a to 81c as an integrated undercut portion 81e. Further, the CPU 104 determines that the slide mold arranged in the undercut portion 81e may be removed from the molded product by sliding in the sliding direction SL1 determined as the common sliding direction.

Thereby, the information processing apparatus 100 may make the respective slide molds arranged in the plurality of undercut portions common, and by reducing the number of slide molds, the number of components of the molds can be suppressed, the structure thereof can be simplified, and the rising of manufacturing cost of the mold can be suppressed.

Since the undercut portion 81d serves as the downstream-side space 54 in the sliding direction SL3, information that the undercut portion 81d is not an undercut in the sliding direction SL3 is assigned thereto. Therefore, the CPU 104 determines that by sliding the slide mold arranged in the undercut portion 81d in the sliding direction SL3, the sliding mold may be removed from the molded product.

The information set as the integrated undercut portion 81e and the information of the result of determining the sliding direction of the slide molds arranged in each of the undercut portions 81d and 81e are stored in the data storage unit 103 by the CPU 104.

### Step S10

In step S10, the CPU 104 sets up the mold opening direction and the sliding direction. The CPU 104 reads the respective data of the information as a result of determining the sliding direction of the slide molds arranged in each of the undercut portions 81d and 81e in the mold opening directions C1 and C2 from the data storage unit 103. The CPU 104 sets the mold opening directions C1 and C2 set by the processing of step S3 as the mold opening directions. Further, based on the result determined in the processing of step S9, the CPU 104 sets the sliding direction of the slide molds arranged in each of the undercut portions.

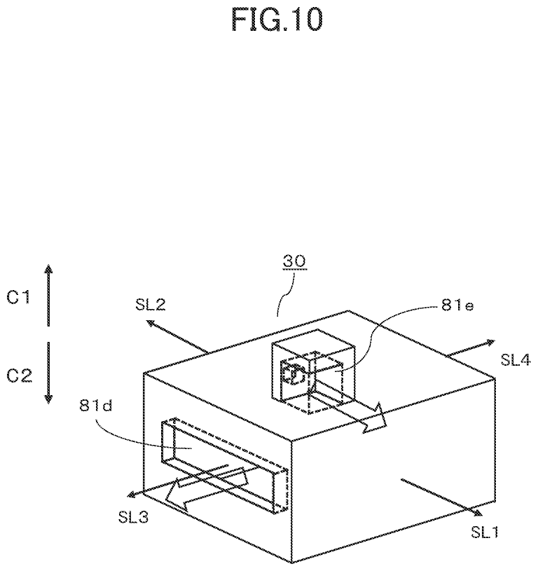

FIG. 10 is a view illustrating the result of the mold opening direction and the sliding direction set by the processing of step S10. As described above, the undercut portion 81e is formed by integrating the undercut portions 81a to 81c determined as having the same sliding direction SL1 as the sliding direction of the slide molds being arranged therein. Therefore, the CPU 104 sets the sliding direction SL1 as the sliding direction of the slide mold arranged in the undercut portion 81e.

Further, the undercut portion 81d is determined as having a single sliding direction SL3 as the sliding direction of the slide mold being arranged therein. Therefore, the CPU 104 sets the sliding direction SL3 as the sliding direction of the slide mold arranged in the undercut portion 81d.

The information of the mold opening directions C1 and C2 being set is stored in the data storage unit 103 by the CPU 104. Further, the information of the sliding direction SL1 of the slide mold arranged in the undercut portion 81e and the sliding direction SL3 of the slide mold arranged in the undercut portion 81d is stored in the data storage unit 103 by the CPU 104.

The CPU 104 displays the mold opening directions C1 and C2 being set, the sliding direction SL1 of the slide mold arranged in the undercut portion 81e, and the sliding direction SL3 of the slide mold arranged in the undercut portion 81d on the display unit 102.

As described, the CPU 104 sets the direction assigned in the extraction information as not being an undercut among the sliding directions SL1 to SL4 that differs from the mold opening directions C1 and C2 as a sliding direction of the slide mold. Thereby, the information processing apparatus 100 may remove the slide mold arranged in the undercut portion without fail from the molded product when opening the cavity mold and the core mold in the mold opening directions C1 and C2, and enables to prevent non-moldability where the mold cannot be removed from the molded product. The sliding direction to which the extraction information that it is not an undercut is assigned constitutes a second direction in the first embodiment.

### Step S11

In step S11, the CPU 104 creates a parting line that serves as a line that indicates a boundary between a cavity mold and a core mold in a molding surface that defines a shape of the molded product, or a line that indicates a position where the mold is divided when the mold is opened to remove the molded product from the mold. The CPU 104 reads the undercut portion information extracted by the processing of step S8, the information of the mold opening direction set by the processing of step S10, and the information on the sliding direction of the respective slide molds from the data storage unit 103.

The CPU 104 sets a surface to be formed by the cavity mold in the three-dimensional shape data 30 as the cavity mold surface from the various information being read. Further, the CPU 104 sets the surface to be formed by the core mold in the three-dimensional shape data 30 as the core mold surface from the various information being read. Further, the CPU 104 sets the surface to be formed by the slide mold in the three-dimensional shape data 30 as the slide mold surface from the various information being read.

Then, the CPU 104 creates a parting line for each of the boundary between the cavity mold surface and the core mold surface, the boundary between the cavity mold surface and the slide mold surface, and the boundary between the core mold surface and the slide mold surface. The information of the parting line being created is stored in the data storage unit 103 by the CPU 104. Regarding the information of the parting line being created, the CPU 104 may, in some cases, store the information in an external storage device or transmit the information to an external computer through the communication unit 107.

### Step S12

In step S12, the CPU 104 designs the shape of a mold. The CPU 104 reads the parting line information created in the processing of step S11 from the data storage unit 103. The CPU 104 creates shape data of the cavity mold, the core mold, and the slide mold, respectively, from the parting line information being read. Each shape data of the respective cavity mold, the core mold, and the slide mold being created is stored in the data storage unit 103 by the CPU 104. Regarding the respective shape data of the cavity mold, the core mold, and the slide mold being created, the CPU 104 may, in some cases, store the data in an external storage device or transmit the data to an external computer through the communication unit 107.

### Summary of First Embodiment

As described, the information processing apparatus 100 according to the first embodiment extracts a three-dimensional space serving as an undercut portion when opening the cavity mold and the core mold for forming a molded product from the rectangular parallelepiped space 51 that encloses the three-dimensional shape data 30 illustrating the three-dimensional shape of the molded product. Thereby, the information processing apparatus 100 may cause the operator to visually recognize the areas serving as the undercut portion in the three-dimensional space, and the operator may distinguish the undercut shape easily. Further, the extracted three-dimensional space may be used to design the slide mold, such that it contributes advantageously to optimizing the efficiency of designing molds. Such an information processing method may be applied not only to the designing of molds, but to checking or inspecting of the mold being designed or manufactured, or to a presentation of a mold being designed or manufactured.

### Second Embodiment

Next, an information processing apparatus 100 according to a second embodiment will be described. In a case where there is a plurality of candidates of a mold opening direction in which the cavity mold and the core mold may be opened, the information processing apparatus 100 according to the second embodiment determines a sliding direction capable of molding a three-dimensional shape data of a molded product for each candidate of the mold opening direction. The information processing apparatus 100 according to the second embodiment determines a sliding direction of a slide mold for each candidate of the mold opening direction, and based on the determined result, sets a most suitable mold opening direction and sliding direction, and displays the mold opening direction and the sliding direction being set on the display unit 102. In this point, the information processing apparatus 100 according to the second embodiment differs from the first embodiment described above. The other configurations are similar to the first embodiment, such that the components common to the first embodiment are denoted with the same reference numbers, the control processing common to the first embodiment are denoted with the same step numbers, and descriptions thereof are omitted.

### Information Processing Method

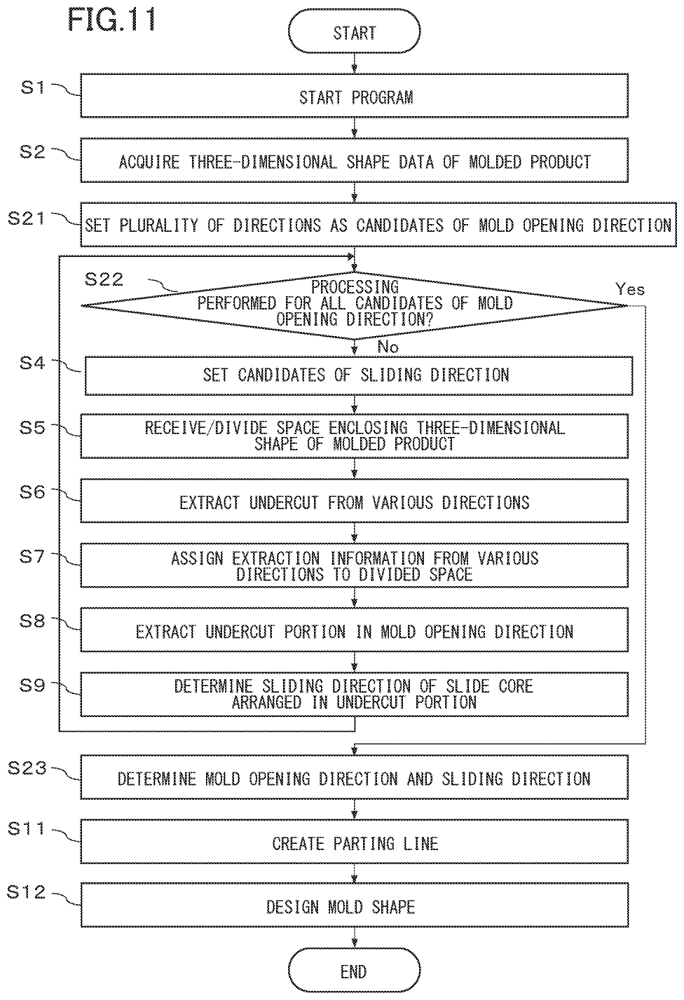

A procedure of an information processing method according to the second embodiment will be described with reference to the flowchart illustrated in FIG. 11.

### Step S2

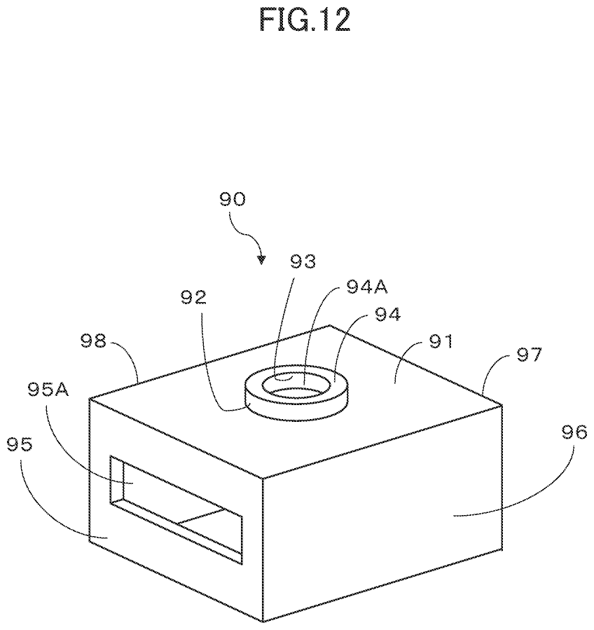

In step S2, the CPU 104 prepares a three-dimensional shape data of a molded product that the mold is designed to form. As an example, a three-dimensional shape data 90 of the mold product whose shape is illustrated in FIG. 12 is described as an example.

As illustrated in FIG. 12, three-dimensional shape data 90 is data that serves as a molded product area that indicates a three-dimensional shape of a molded product. The three-dimensional shape data 90 has a shape including an outer circumference surface 92, an inner circumference surface 93, and an upper surface 94 that constitute a cylindrical shape extending upward in the drawing from a surface 91. A hole 94A having a round hole shape is formed on the upper surface 94, and the surface 91 constitutes a bottom surface of the hole 94A. Further, the three-dimensional shape data 90 constitutes a shape having surfaces 95 to 98 that extend downward in the drawing from the surface 91. The surface 95 is opposed to the surface 97, and the surface 96 is opposed to the surface 98. A hole 95A having a quadrangular hole shape is formed on the surface 95.

If the three-dimensional shape data 90 is already stored in the data storage unit 103, the operator designates and receives the corresponding data through the input unit 101. If the three-dimensional shape data 90 is not yet stored in the information processing apparatus 100, the operator instructs through the input unit 101 to acquire the corresponding data from a location of the corresponding data, such as the CAD 109 or the external storage device 108, through the communication unit 107. When the three-dimensional shape data 90 is prepared, the CPU 104 displays the 3-D model illustrated in FIG. 12, for example, on the display unit 102.

### Step S21

In step S21, the operator enters, i.e., sets, a candidate of the mold opening direction. The operator refers to the three-dimensional shape data 90, i.e., 3-D model, displayed on the display unit 102, and enters, i.e., sets, a plurality of candidates of the mold opening direction for opening the cavity mold and the core mold through the input unit 101. The information related to the candidates of the mold opening direction being set is stored in the data storage unit 103 by the CPU 104. A method for setting candidates of the mold opening direction may be configured to be executed by a method similar to the method for setting the mold opening direction executed in the processing of step S3 of FIG. 2 described above. Each time a candidate of the mold opening direction is set, the CPU 104 stores the candidate of the mold opening direction being entered to the data storage unit 103, by which the plurality of candidates of the mold opening direction may be stored in the data storage unit 103.

### Step S22

In step S22, the CPU 104 determines whether the processing of steps S4 to S9 have been executed for all the candidates of the mold opening direction being set. The CPU 104 reads the data of the candidates of the mold opening direction from the data storage unit 103, and determines whether the data of the candidates of the mold opening direction being read is associated with respective data created by the processing of steps S4 to S9. If any of the data of candidates of the mold opening direction is not associated with the respective data created by the processing of steps S4 to S9 (No), the CPU 104 advances the processing to step S4. Meanwhile, if all the data of the candidates of the mold opening direction are associated with the respective data created by the processing of steps S4 to S9 (Yes), the CPU 104 advances the processing to step S23.

### Steps S4 to S9

The CPU 104 executes the processing of steps S4 to S9 for each candidate of one set of mold opening directions, and after the processing of step S9 is completed, the processing is returned to step S22.

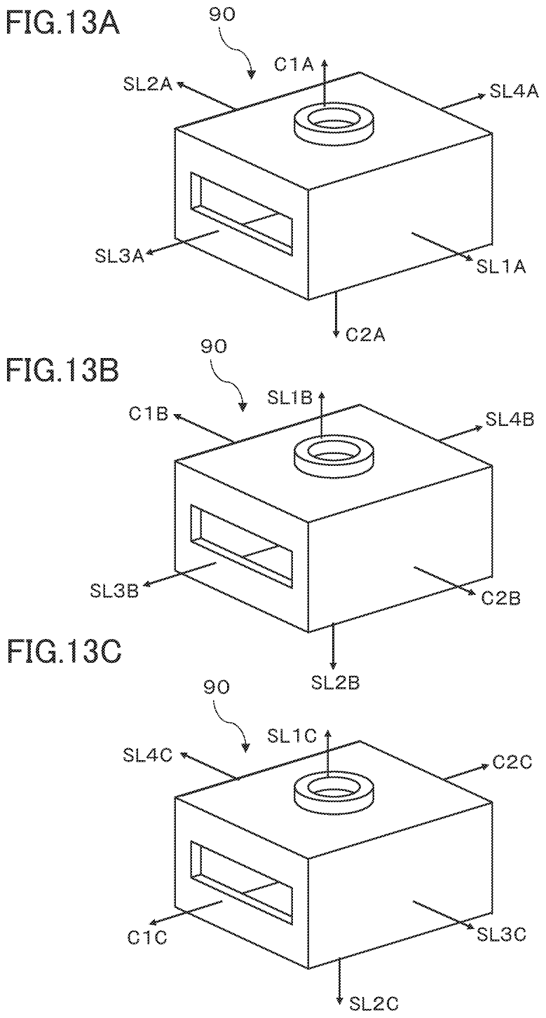

FIG. 13A is a view illustrating a case where directions corresponding to a normal line vector of the surface 91 are entered as mold opening directions C1A and C2A. As illustrated in FIG. 13A, in a state where the mold opening directions C1A and C2A are entered as candidates of the mold opening direction, the CPU 104 sets sliding directions SL1A to SL4A as candidates of the sliding direction by executing the processing of step S4.

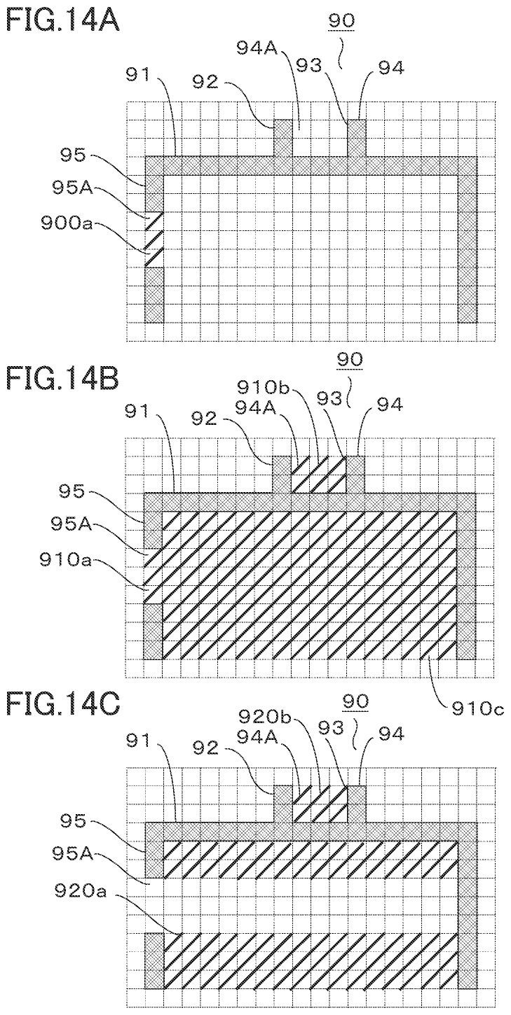

FIG. 14A is a view illustrating an undercut portion in a case where the cavity mold and the core mold are opened in the mold opening directions CIA and C2A with reference to the cross-sectional view of the three-dimensional shape data 90 in the mold opening direction CIA. When the mold opening directions are CIA and C2A, the CPU 104 executes the processing of steps S5 to S9 to extract polyhedrons included in the three-dimensional space surrounded by the hole 95A of the three-dimensional shape data 90 as an undercut portion 900a. The CPU 104 determines that the slide mold arranged in the undercut portion 900a may be removed from the molded product by sliding the slide mold in the sliding direction SL3A.

FIG. 13B is a view illustrating a case where directions corresponding to a normal line vector of the surface 96 are entered as mold opening directions C1B and C2B. As illustrated in FIG. 13B, in a state where the mold opening directions C1B and C2B are entered as candidates of the mold opening direction, the CPU 104 sets sliding directions SL1B to SL4B as candidates of the sliding direction by executing the processing of step S4.

FIG. 14B is a view illustrating an undercut portion in a case where the cavity mold and the core mold are opened in the mold opening directions C1B and C2B with reference to the cross-sectional view of the three-dimensional shape data 90 in the mold opening direction CIA. When the mold opening directions are C1B and C2B, the CPU 104 executes the processing of steps S5 to S9 to extract polyhedrons included in the three-dimensional space surrounded by the hole 95A of the three-dimensional shape data 90 as an undercut portion 910a. Further, the CPU 104 extracts polyhedrons included in the three-dimensional space surrounded by the hole 94A and the surface 91 of the three-dimensional shape data 90 as an undercut portion 910b. Further, the CPU 104 extracts polyhedrons included in the three-dimensional space surrounded by the surface 96 and the surface 98 opposed to the surface 96 as an undercut portion 910c.

The CPU 104 determines that the slide mold arranged in the undercut portion 910a may be removed from the molded product by sliding the slide mold in the sliding direction SL3B. Further, the CPU 104 determines that the slide mold arranged in the undercut portion 910b may be removed from the molded product by sliding the slide mold in the sliding direction SL1B. Further, the CPU 104 determines that the slide mold arranged in the undercut portion 910c may be removed from the molded product by sliding the slide mold in the sliding direction SL2B.

FIG. 13C is a view illustrating a case where directions corresponding to a normal line vector of the surface 95 are entered as mold opening directions C1C and C2C. As illustrated in FIG. 13C, in a state where the mold opening directions C1C and C2C are entered as candidates of the mold opening direction, the CPU 104 sets sliding directions SL1C to SL4C as candidates of the sliding direction by executing the processing of step S4.

FIG. 14C is a view illustrating an undercut portion in a case where the cavity mold and the core mold are opened in the mold opening directions C1C and C2C with reference to the cross-sectional view of the three-dimensional shape data 90 in the mold opening direction CIA. When the mold opening directions are C1C and C2C, the CPU 104 executes the processing of steps S5 to S9 to extract polyhedrons included in the three-dimensional space surrounded by the hole 94A and the surface 91 of the three-dimensional shape data 90 as an undercut portion 920a. Further, the CPU 104 extracts polyhedrons included in the three-dimensional space surrounded by the surface 95 and the surface 97 as an undercut portion 920b.

The CPU 104 determines that the slide mold arranged in the undercut portion 920a may be removed from the molded product by sliding the slide mold in the sliding direction SL1C. Further, the CPU 104 determines that the slide mold arranged in the undercut portion 920b may be removed from the molded product by sliding the slide mold in the sliding direction SL2C.

### Step S23

In step S23, the CPU 104 sets the mold opening direction and the sliding direction. The CPU 104 reads respective data of candidate information of the mold opening directions and information of results being determined as the sliding directions of the slide mold arranged in the undercut portion for each mold opening direction from the data storage unit 103. The CPU 104 sets an optimum mold opening direction based on respective data being read, and sets a determination result of the sliding direction of the slide mold for the set mold opening direction as the sliding direction of the relevant slide mold.

The CPU 104 sets the candidate of the mold opening direction whose number of slide molds necessary for the undercut portions becomes smallest as the mold opening direction, for example. In other words, the CPU 104 sets the candidate of the mold opening direction whose number, or variety, of candidates of the sliding direction of the slide mold arranged in the undercut portions becomes smallest as the mold opening direction.

Thereby, if there are a plurality of directions that may be set as the mold opening direction, the information processing apparatus 100 sets the mold opening direction where the number of slide molds becomes smallest, thereby suppressing the number of components of the mold and simplifying the structure thereof, according to which the rising of manufacturing costs of the mold may be suppressed.

The information processing apparatus 100 is not limited to automatically setting one direction among a plurality of mold opening direction candidates, and may be configured to have an operator select one direction among the plurality of mold opening direction candidates.

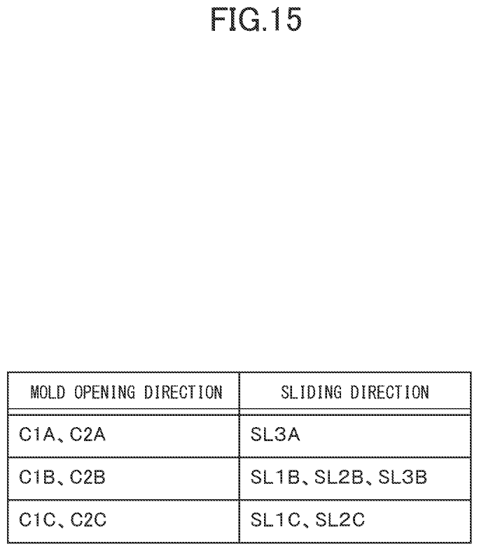

FIG. 15 is a table summarizing the determination result of the sliding directions of the slide mold arranged in each undercut portion by the processing performed in steps S4 to S9 for each of the mold opening direction candidates. The CPU 104 displays the table illustrated in FIG. 15 on the display unit 102. The operator may select through the input unit 101 any one of the mold opening directions based on the mold opening direction candidates being displayed and the number of sliding directions corresponding to that candidate. The CPU 104 sets the mold opening direction candidate selected by the operator as the mold opening direction of the cavity mold and the core mold, and sets the sliding direction of the slide mold arranged in the undercut portion corresponding to that mold opening direction.

The CPU 104 displays the mold opening direction and the sliding direction of the slide mold determined by the processing of step S23 on the display unit 102.

### Step S11

In step S11, the CPU 104 reads the information of the mold opening direction of the cavity mold and the core mold determined in the processing of step S23 from the data storage unit 103. Further, the CPU 104 reads the information of the sliding direction of the slide mold arranged in the undercut portion when opening the cavity mold and the core mold in the mold opening direction from the data storage unit 103.

The CPU 104 sets the cavity mold surface, the core mold surface, and the slide mold surface in the three-dimensional shape data 90 from the respective information being read. Then, the CPU 104 creates a parting line for each of the boundary between the cavity mold surface and the core mold surface, the boundary between the cavity mold surface and the slide mold surface, and the boundary between the core mold surface and the slide mold surface.

The CPU 104 creates a shape data of each of the cavity mold, the core mold, and the slide mold from the parting line information. The created parting line information and the shape data of each of the cavity mold, the core mold, and the slide mold are stored in the data storage unit 103 by the CPU 104. The created parting line information and the shape data of each of the cavity mold, the core mold, and the slide mold may also be stored in an external storage device or transmitted to an external computer through the communication unit 107 by the CPU 104.

### Summary of Second Embodiment

As described, the information processing apparatus 100 according to the second embodiment may set a mold opening direction where the number of slide molds become smallest among a plurality of mold opening direction candidates. Thereby, the information processing apparatus 100 may suppress the number of components of the mold and simplify the structure. Therefore, the information processing apparatus 100 may reduce mold manufacturing costs and mold designing costs such as costs for changing the design to a more efficient mold or costs for confirming and checking the design change as costs related to the mold. Further, the information processing apparatus 100 may reduce shipping costs and maintenance costs as costs related to the mold. Further, the information processing apparatus 100 may reduce manufacturing costs of the molded product by reducing the energy used for moving the slide mold as costs related to the mold.

The present technique is not limited to the embodiments and examples described above, and various modifications are enabled within the technical concept of the present technique.

Further, the first and second embodiments illustrates an example where the cavity mold, i.e., stationary mold, and the core mold, i.e., movable mold, are set in advance before creating the parting line, but the present technique is not limited thereto. That is, in the stage of creating a parting line of two molds, i.e., a first mold and a second mold, it is not necessary to determine which of the two molds is the core mold and which is the cavity mold. It may be possible to set the cavity mold and the core mold after creating the parting line, or it may be possible to temporarily set the cavity mold and the core mold prior to creating the parting line and to determine the setting of the cavity mold and the core mold after creating the parting line.

In the first and second embodiments, the CPU 104 is configured to determine the polyhedrons 52 set as the undercut for each direction according to the processing of step S6, but the present technique is not limited thereto. The CPU 104 may be configured to determine whether the polyhedrons 52 constitute an undercut from two directions, one direction and the direction opposed thereto.

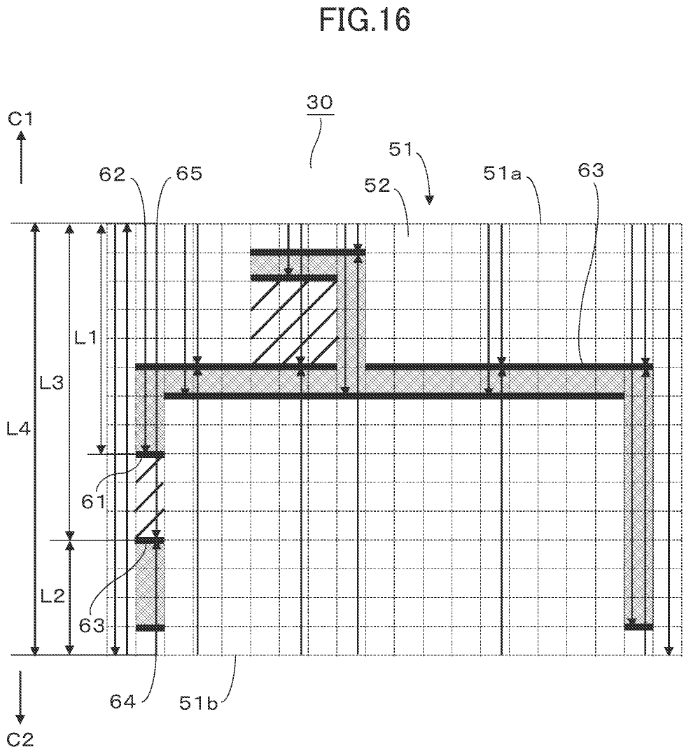

The configuration is described in detail with reference to FIG. 16. As illustrated in FIG. 16, at first, the CPU 104 draws the rear surface 61 of the three-dimensional shape data 30 in the mold opening direction C1. Next, the CPU 104 draws a rear surface 63 in the mold opening direction C2 which is the direction opposed to the mold opening direction C1. Next, the CPU 104 extends the straight line 62 from the downstream end 51a of the rectangular parallelepiped space 51 in the mold opening direction C1, and acquires a length L1 to the rear surface 61 where the straight line 62 first reaches. Next, the CPU 104 extends a straight line 64 from a downstream end 51b of the rectangular parallelepiped space 51 in the mold opening direction C2, and acquires a length L2 from the downstream end 51b to the rear surface 63. Next, the CPU 104 extends a straight line 65 from the downstream end 51a of the rectangular parallelepiped space 51 in the mold opening direction C1, and acquires a length L3 from the downstream end 51a to the rear surface 63. In this state, the CPU 104 computes the length L3 by subtracting the length L2 from a length L4 of the mold opening directions C1 and C2 of the rectangular parallelepiped space 51. Then, the CPU 104 determines that an undercut portion exists within the range between the rear surface 61 and the rear surface 63 in a case where the length L1 from the downstream end 51a to the rear surface 61 is shorter than the length L3 from the downstream end 51a to the rear surface 63.

By adopting the configuration described above, the information processing apparatus 100 may determine undercut portions for two directions by one processing, and an undercut information may be set accurately by a simple processing that has little impact on the shape of the molded product.

The rear surface 61 constitutes a first boundary, the rear surface 63 constitutes a second boundary, the length L1 constitutes a first length, and the length L3 constitutes a second length.

A program for executing the information processing technique described above and a computer-readable storage medium storing that program are included in the embodiments of the present disclosure. Further, a designing method of a mold using the information processing technique described above is also included in the embodiments of the present invention. Further, a manufacturing method of a mold manufactured by the information processing technique described above and a manufacturing method of a molded product that manufactures the molded product using the mold manufactured by that manufacturing method are also included in the embodiments of the present invention.

The present invention may be realized by a processing of supplying a program for realizing one or more functions of the present embodiment via a network or a storage medium to a system or a device and having one or more processors of the system or a computer of the apparatus read and execute the program. Further, the present invention may be realized by a circuit, such as ASIC, that realizes one or more functions.

### Third Embodiment

Next, a third embodiment will be described. The same components as the first embodiment are denoted with the same reference numbers, and detailed descriptions thereof are omitted. According to the method disclosed in Japanese Patent Application Laid-Open Publication No. 2013-63623, a parting line of a slide core is created targeting one undercut shape. Generally, if individual slide cores are created for each of the plurality of undercut shapes, the number of components of the mold is increased, and the structure becomes complex. Due to the increase in the number of components and the complication of the structure, various costs related to the mold, such as the manufacturing costs of the mold, the design costs of the mold, the shipping costs of the mold, the maintenance costs, and the manufacturing costs of the molded product, are increased. Therefore, according to Japanese Patent Application Laid-Open Publication No. 2013-63623, it is difficult to reduce the costs related to the mold when forming a molded product having a plurality of undercut shapes.

### Information Processing Method

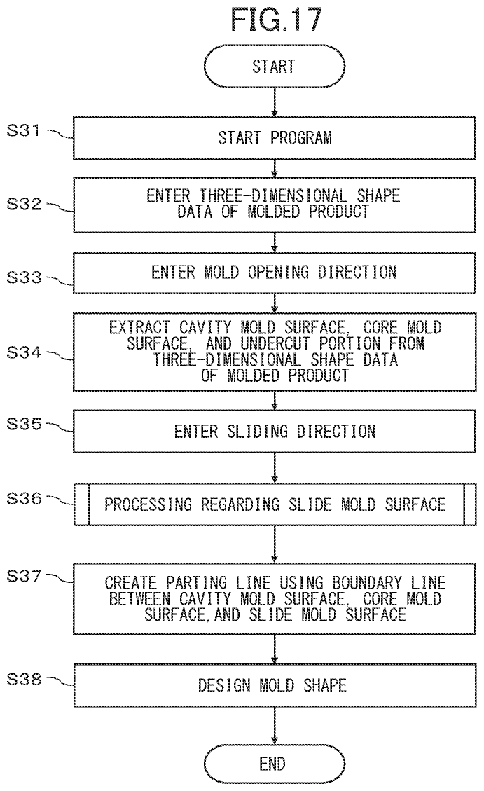

A procedure of an information processing method according to the present embodiment will be described with reference to a flowchart of FIG. 17.

### Step S31

In step S31, in a state where a start information from an operator is received through the input unit 101 by the information processing apparatus 100, the CPU 104 reads a mold generation processing program stored in the ROM 105, and starts executing the same.

### Step S32

In step S32, the CPU 104 prepares a three-dimensional shape data of a molded product that the mold is designed to manufacture.

### Step S33

In step S33, the operator enters, i.e., sets, a mold opening direction. The operator refers to the three-dimensional shape data, i.e., 3-D model, displayed on the display unit 102, and enters, or sets, mold opening directions for opening the cavity mold and the core mold through the input unit 101. Information related to the mold opening directions being set is stored by the CPU 104 in the data storage unit 103. Methods for setting the mold opening direction include, for example, a method for designating a vector of the mold opening direction, and a method for selecting an arbitrary outer surface and setting a normal line vector of the selected surface as the mold opening direction. Further, the methods may include a method for setting a direction parallel to an arbitrary edge of an outer surface of the molded product as a mold opening direction, or a method for estimating a vector of the mold opening direction from the three-dimensional shape data of the molded product, but are not limited thereto.

While performing the processing of step S33, the CPU 104 may display the image showing the three-dimensional shape data on the display unit 102, for example.

### Step S34

In step S34, the CPU 104 extracts a cavity mold surface which is a surface moldable by the cavity mold and a core mold surface which is a surface moldable by the core mold among the respective surfaces of the three-dimensional shape data of the molded product. Further, the CPU 104 extracts an undercut portion which is an assembly of non-moldable surfaces of the cavity mold and the core mold and which is an assembly of adjacent surfaces. The information of the extracted cavity mold surface, core mold surface, and undercut portion are stored in the data storage unit 103 by the CPU 104. Methods for extracting the cavity mold surface, the core mold surface, and the undercut portion include, for example, a method of calling the mold opening direction from the data storage unit 103 by the CPU 104 and estimating the surfaces based on points on edges constituting respective surfaces of the three-dimensional shape data of the molded product. The methods may also include a method of extending a vector from an arbitrary point on the surface, or a method of extending a vector from a designated position on the surface, but are not limited thereto.

The processing of step S34 constitutes a processing of extracting a plurality of undercut portions serving as undercut when opening the cavity mold as a first mold and a core mold as a second mold for molding the molded product.

### Step S35

In step S35, the CPU 104 enters a sliding direction which is a direction of removing the slide mold arranged in the undercut portion from the molded product. The entered sliding direction is stored in the data storage unit 103 by the CPU 104. Methods for entering the sliding direction include a method for selecting a vector of the sliding direction, and a method for estimating a sliding direction from the three-dimensional shape data of the molded product, but are not limited thereto.

This processing of step S35 constitute a processing of setting a sliding direction of removing the slide mold arranged in the undercut portion from the molded product for each of the plurality of undercut portions.

### Step S36

In step S36, the CPU 104 executes a processing regarding the slide mold surface. In this processing, the CPU 104 reads the information of the undercut portion extracted in the processing of step S34 and the information of the sliding direction entered by the processing of step S35 from the data storage unit 103. The CPU 104 determines the presence or absence of undercut portions capable of having arranged therein a slide mold that is slid in the same sliding direction based on the undercut portion information and the sliding direction information being read.

Based on the result having determined the presence/absence of undercut portions capable of arranging a slide mold that is slid in the same sliding direction, the CPU 104 extracts a plurality of undercut portions in which a single slide mold may be arranged. Further, the CPU 104 extracts slide mold surfaces that are moldable by a single slide mold arranged in the plurality of undercut portions. When it is determined that the slide mold that is slid in the same sliding direction is not arranged in the plurality of undercut portions, the CPU 104 extracts slide mold surfaces that are molded by different slide molds.

This processing of step S36 constitutes an extraction processing of extracting at least two undercut portions in which a single slide mold is arranged among the plurality of undercut portions.

### Processing Regarding Slide Mold Surface

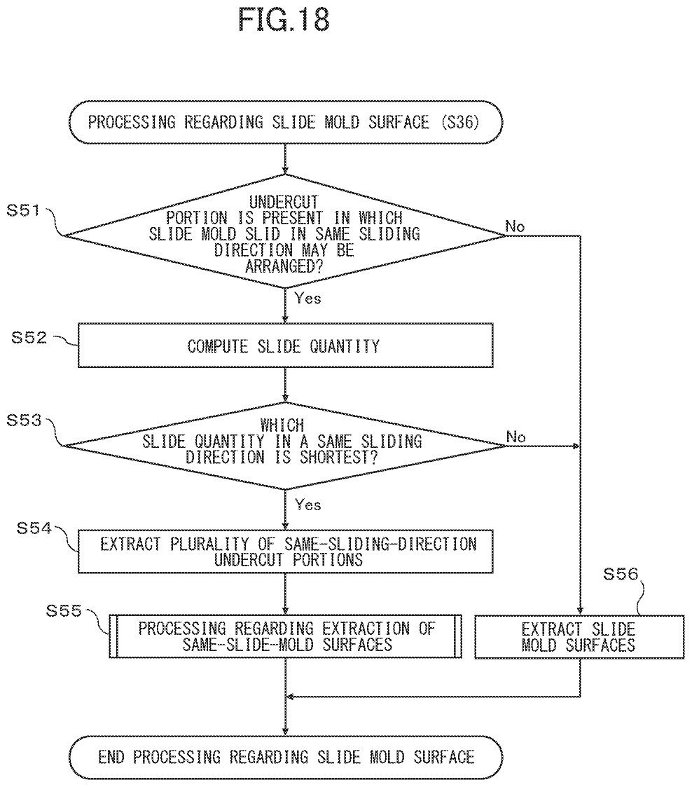

FIG. 18 is a flowchart illustrating a processing executed by the CPU 104 in the processing of step S36.

### Step S51

In step S51, the CPU 104 determines the presence/absence of a plurality of undercut portions in which a slide mold slid in the same sliding direction may be arranged based on the information of the undercut portions and the information of the sliding directions being read. If it is determined that there is no slide mold that is slid in the same sliding direction (No), the CPU 104 advances the processing to step S56. Meanwhile, if it is determined that there are slide molds that are slid in the same sliding direction (Yes), the CPU 104 advances the processing to step S52.

### Step S52

In step S52, the CPU 104 computes a slide quantity which is a distance that the slide mold is moved when being removed from a molded product. The CPU 104 reads the information of the undercut portions and the information of the sliding directions of the slide mold from the data storage unit 103. The CPU 104 computes an area from an end portion of an undercut portion on the upstream side in the sliding direction to an end portion in the three-dimensional shape data of the molded product on the downstream side in the sliding direction as a slide quantity. The slide quantity information being computed is stored in the data storage unit 103 by the CPU 104.

### Step S53

In step S53, the CPU 104 determines whether the slide quantity of the same sliding direction in a slide mold that is slid in the same sliding direction is shorter than a slide quantity of that slide mold in anther sliding direction. The CPU 104 reads the information of the undercut portions, the information of the sliding directions of the slide molds, and the information of the slide quantity of each slide mold in each sliding direction from the data storage unit 103. The CPU 104 compares slide quantities of respective sliding directions for slide molds that may be arranged in each of the plurality of undercut portions determined to allow arrangement of slide molds that are slid in the same sliding direction. Information of the result having compared the slide quantities is stored in the data storage unit 103 by the CPU 104.

If it is determined that the slide quantity in a different sliding direction of that slide mold is smaller than the slide quantity in the same sliding direction (No), the CPU 104 advances the processing to step S56. Meanwhile, if it is determined that the slide quantity is smallest for that slide mold in the slide quantity in the same sliding direction (Yes), the CPU 104 advances the processing to step S54.

### Step S54

In step S54, the CPU 104 extracts a plurality of undercut portions as undercut portions in which a slide mold slid in the same direction as the sliding direction are each arranged, i.e., a plurality of same-sliding-direction undercut portions. The CPU 104 reads the undercut portion information, the sliding direction information of slide molds, and the slide quantity information of each slide mold in each sliding direction from the data storage unit 103. Further, the CPU 104 reads the information of the results having compared the slide quantity of each slide mold in each sliding direction from the data storage unit 103. The CPU 104 extracts a plurality of same-sliding-direction undercut portions in which a mold is slid in the same direction and to the sliding direction whose slide quantity is smallest from the information being read.

The information of the plurality of same-sliding-direction undercut portions, the information of the sliding direction being the same direction, and the information of the slide quantity of the slide mold in that same sliding direction being computed are stored in the data storage unit 103 by the CPU 104. After executing the processing of step S54, the CPU 104 advances the processing to step S55.

Further, in the processing of S54, the CPU 104 displays surfaces where the plurality of same-sliding-direction undercut portions being extracted adjoin the three-dimensional shape data of the molded product on the display unit 102.

Thereby, the information processing apparatus 100 enables the operator to visually recognize which areas of the three-dimensional shape of the molded product serve as the same-sliding-direction undercut portions. Then, the information processing apparatus 100 enables the operator to easily distinguish the same slide mold surfaces.

The processing of steps S53 and S54 constitute a processing of setting, in a case where there are a plurality of sliding direction candidates of the slide mold, the direction in which an amount of movement when removing the slide mold from the molded product becomes smallest as the sliding direction.

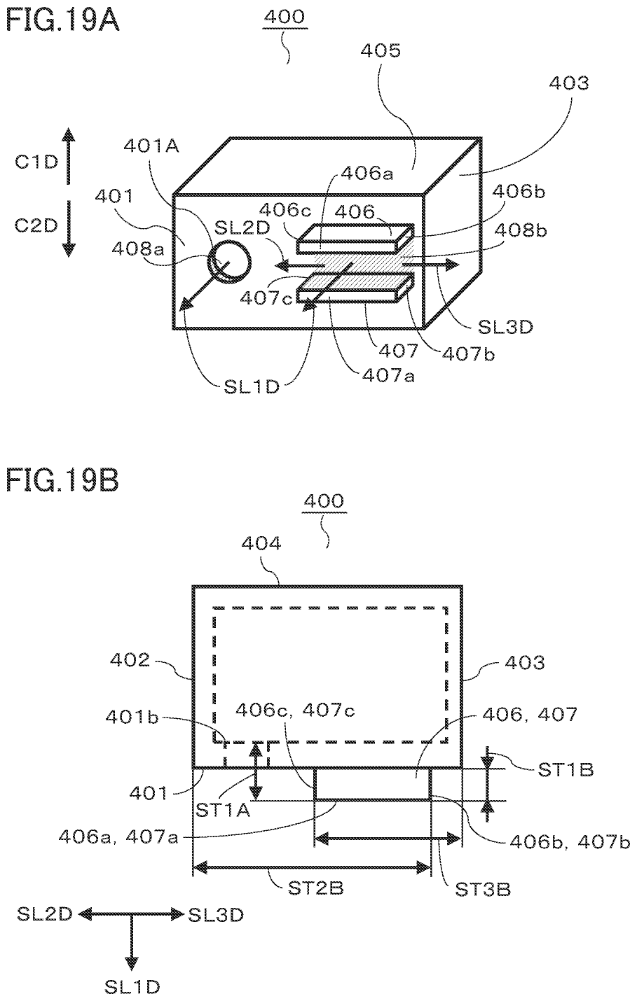

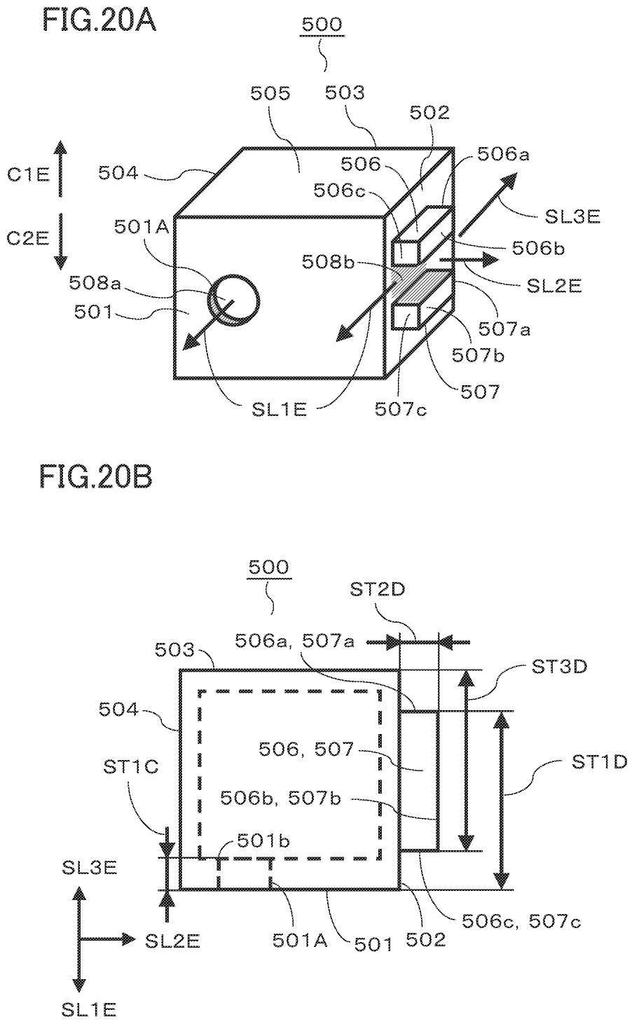

The processing of steps S51 to S54 will be described in detail with reference to FIGS. 19A to 20B. FIG. 19A is a perspective view illustrating a three-dimensional shape data 400 as a three-dimensional shape data of a molded product, and FIG. 19B is a top view illustrating the three-dimensional shape data 400. As illustrated in FIGS. 19A and 19B, the three-dimensional shape data 400 has a shape in which a quadrangle shape surrounded by surfaces 401 to 404 is covered by an upper surface 405, and wherein mold opening directions of a cavity mold and a core mold are set to mold opening directions C1D and C2D. A hole 401A having a round hole shape is formed on the surface 401. Further, a pair of wall portions 406 and 407 that extend vertically from the surface 401 is formed on the surface 401. The wall portions 406 and 407 are formed to have similar rectangular parallelepiped shapes.

As illustrated in FIG. 19A, according to the three-dimensional shape data 400 set in the mold opening directions C1D and C2D, the three-dimensional space surrounded by the hole 401A in the mold opening directions C1D and C2D constitutes an undercut portion 408a. Further, according to the three-dimensional shape data 400, the space surrounded by the pair of wall portions 406 and 407 in the mold opening directions CM and C2D constitutes an undercut portion 408b.

The slide mold arranged in the undercut portion 408a may be removed from the molded product by sliding in a sliding direction SL1D. The slide mold arranged in the undercut portion 408b may be removed from the molded product by sliding in sliding directions SL1D, SL2D, and SL3D.

That is, regarding the slide mold arranged in the undercut portion 408a and the slide mold arranged in the undercut portion 408b, the same sliding direction SL1D is set as the sliding direction for removal from the molded product. In the processing of step S51, the CPU 104 determines that a slide mold capable of being slid in the same sliding direction SL1D may be arranged in the undercut portions 408a and 408b, and advances the processing to step S52.

In the processing of step S52, the CPU 104 computes the slide quantity of the slide mold arranged in the undercut portion 408a. Further, the CPU 104 computes the slide quantity for each of the sliding directions of the slide mold arranged in the undercut portion 408b, since there are three sliding directions SL1D to SL3D set as the sliding directions thereof.

The slide quantity of the slide mold arranged in the undercut portion 408a is a slide quantity ST1A from an upstream end portion 401b of the hole 401A in the sliding direction SL1D to downstream-side end surfaces 406a and 407a of the wall portions 406 and 407 in the sliding direction SL1D.

The slide quantity of the slide mold arranged in the undercut portion 408b when sliding in the sliding direction SL1D is a slide quantity ST1B from the surface 401 to the end surfaces 406a and 407a of the wall portions 406 and 407. Further, the slide quantity of the slide mold arranged in the undercut portion 408b when sliding in the sliding direction SL2D is a slide quantity ST2B from end surfaces 406b and 407b arranged upstream of the wall portions 406 and 407 in the sliding direction SL2D to the surface 402. Further, the slide quantity of the slide mold arranged in the undercut portion 408b when sliding in the sliding direction SL3D is a slide quantity ST3B from end surfaces 406c and 407c arranged upstream of the wall portions 406 and 407 in the sliding direction SL3D to the surface 403. Then, as illustrated in FIG. 19B, in the slide quantities ST1B to ST3B, the slide quantity ST1B is the smallest and the slide quantity ST2B is the greatest.

In the processing of step S53, the CPU 104 determines that the slide quantity is smallest in the slide molds arranged in each of the undercut portions 408a and 408b of the slide quantity ST1A of the same sliding direction SL1D. Then, the CPU 104 advances the processing to step S54, and acquires the undercut portions 408a and 408b as the plurality of same-sliding-direction undercut portions.

FIG. 20A is a perspective view illustrating a perspective view of a three-dimensional shape data 500 serving as three-dimensional shape data of a molded product, and FIG. 20B is a top view illustrating the three-dimensional shape data 500. As illustrated in FIGS. 20A and 20B, the three-dimensional shape data 500 is a shape in which a quadrangle shape surrounded by surfaces 501 to 504 is covered by an upper surface 505, and mold opening directions of the cavity mold and the core mold are set to mold opening directions C1E and C2E. A hole 501A having a round hole shape is formed on the surface 501. Further, a pair of wall portions 506 and 507 extending vertically from the surface 502 is formed on the surface 502 that crosses the surface 501 vertically. The wall portions 506 and 507 have similar rectangular parallelepiped shapes.

As illustrated in FIG. 20A, regarding the three-dimensional shape data 500 set in the mold opening directions C1E and C2E, the three-dimensional space surrounded by the hole 501A in the mold opening directions C1E and C2E constitutes an undercut portion 508a. Further, regarding the three-dimensional shape data 500 set in the mold opening directions C1E and C2E, the space sandwiched between the pair of wall portions 506 and 507 constitutes an undercut portion 508b.

The slide mold arranged in the undercut portion 508a may be removed from the molded product by sliding in a sliding direction SL1E. The slide mold arranged in the undercut portion 508b may be removed from the molded product by sliding in sliding directions SL1E, SL2E, and SL3E.

That is, regarding the slide mold arranged in the undercut portion 508a and the slide mold arranged in the undercut portion 508b, the same sliding direction SL1E is set as the sliding direction for removal from the molded product. In the processing of step S51, the CPU 104 determines that a slide mold capable of being slid in the same sliding direction SL1E may be arranged in the undercut portions 508a and 508b, and advances the processing to step S52.

In the processing of step S52, the CPU 104 computes the slide quantity of the slide mold arranged in the undercut portion 508a. Further, the CPU 104 computes the slide quantity for each of the sliding directions of the slide mold arranged in the undercut portion 508b, since there are three sliding directions SL1E to SL3E set as the sliding directions thereof.

The slide quantity of the slide mold arranged in the undercut portion 508b is a slide quantity ST1C from an upstream end portion 501b of the hole 501A in the sliding direction SL1E to the surface 501.

The slide quantity of the slide mold arranged in the undercut portion 508b when sliding in the sliding direction SL1E is a slide quantity ST1D from upstream end surfaces 506a and 507a of the wall portions 506 and 507 in the sliding direction SL1E to the surface 501. Further, the slide quantity of the slide mold arranged in the undercut portion 508b when sliding in the sliding direction SL2E is a slide quantity ST2D from the surface 502 to downstream end surfaces 506b and 507b of the wall portions 506 and 507 in the sliding direction SL2E. Further, the slide quantity of the slide mold arranged in the undercut portion 508b when sliding in the sliding direction SL3D is the slide quantity ST3B from upstream end surfaces 506c and 507c of the wall portions 506 and 507 in the sliding direction SL3E to a surface 503. Then, as illustrated in FIG. 20B, among the slide quantities ST1D to ST3D, the slide quantity ST2D is the smallest compared to the slide quantities ST1D and ST3D.

In the processing of step S53, the CPU 104 determines that the slide quantity ST2D in the sliding direction SL2E of the slide mold arranged in the undercut portion 508b is smaller than the slide quantity ST1D in the same sliding direction SL1E. Then, the CPU 104 advances the processing from step S53 to step S56.

### Step S55

In step S55, the CPU 104 executes a processing related to extracting slide mold surfaces formed by a same slide mold, i.e., same-slide-mold surfaces, from the respective surfaces of a molded product. The CPU 104 reads the information of a plurality of the same-sliding-direction undercut portions acquired from the data storage unit 103 by the processing of step S54, the information of sliding directions which are the same direction, and slide quantity information of the slide mold being computed. The CPU 104 extracts the same-slide-mold surfaces molded by the same slide mold from the information on the plurality of same-sliding-direction undercut portions being read. The details of this processing will be described later.

This processing of steps S51 to S55 constitute a processing of determining that a same slide mold is arranged in a plurality of undercut portions whose sliding direction of the slide mold is set in the same direction.

### Step S56

In step S56, the CPU 104 extracts slide mold surfaces that are molded by a slide mold arranged in the undercut portion among the respective surfaces of a molded product. The CPU 104 reads a three-dimensional shape data of a molded product, undercut portion information, and sliding direction information of slide molds arranged in each undercut portion from the data storage unit 103. The CPU 104 may adopt, as an extraction method of slide mold surfaces, a method of extracting a surface adjoining an undercut portion and a surface adjacent to an undercut portion as slide mold surfaces, for example, but the method is not limited thereto.

As described, the CPU 104 acquires the plurality of undercut portions in which slide molds sliding in the same direction and in the sliding direction with the smallest slide quantity as the same-sliding-direction undercut portions. Thereby, when suppressing the increase in the number of slide molds, the information processing apparatus 100 may suppress excessive increase in size of the slide molds, such that the size of the mold for molding the molded product may be downsized, and the manufacturing costs of the mold may be suppressed.

### Processing Regarding Extraction of Single Slide Mold Surface

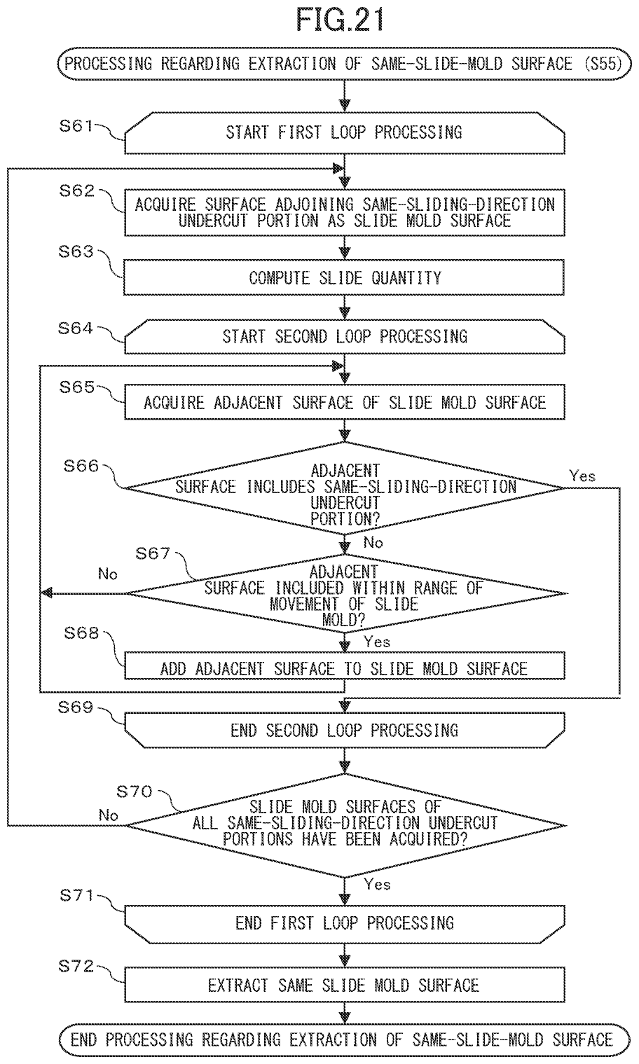

FIG. 21 is a flowchart illustrating a processing executed by the CPU 104 in the processing of step S55.

### Step S61

In step S61, the CPU 104 starts a loop processing that is performed for each of the plurality of same-sliding-direction undercut portions. The CPU 104 starts a first loop processing of performing the processing of steps S62 to S70 for each of the plurality of same-sliding-direction undercut portions.

### Step S62

In step S62, the CPU 104 acquires a surface adjoining one same-sliding-direction undercut portion among the plurality of same-sliding-direction undercut portions in the three-dimensional shape data of the molded product as a slide mold surface.

### Step S63

In step S63, the CPU 104 computes a slide quantity of removing a slide mold arranged in the undercut portion whose slide mold surface has been acquired by the processing of step S62 from the molded product. Approximately similarly as the processing of step S52, the CPU 104 computes the slide quantity of the slide mold arranged in the undercut portion whose slide mold surface has been acquired. The slide quantity being computed is stored in the data storage unit 103 by the CPU 104. The processing of step S63 constitutes a processing of acquiring a range in which the slide mold moves in the sliding direction.

### Step S64

In step S64, the CPU 104 starts a loop processing that is performed for an adjacent surface that is adjacent to the undercut portion whose slide mold surface has been acquired. The CPU 104 starts a second loop processing of performing the processing of steps S65 to S68 for the adjacent surface that is adjacent to the undercut portion whose slide mold surface has been acquired.

### Step S65

In step S65, the CPU 104 acquires the adjacent surface that is adjacent to the surface acquired as the slide mold surface. The CPU 104 acquires the adjacent surface that is adjacent to the surface whose slide mold surface has been acquired as the adjacent surface. Specifically, if the processing is a second loop processing performed for the first time, the CPU 104 acquires a surface adjoining the same-sliding-direction undercut portion acquired as a slide mold surface in the processing of step S62 as the adjacent surface. Further, if the processing is a second loop processing performed for the second time or more, the CPU 104 acquires an adjacent surface to the surface added to the slide mold surface by the previous second loop processing as the adjacent surface. The processing of step S65 constitutes a processing of acquiring the adjacent surface that is adjacent to the undercut portion.

### Step S66

In step S66, the CPU 104 determines whether a same-sliding-direction undercut portion that differs from the undercut portion whose slide mold surface has been acquired in the current first loop processing is included in the adjacent surface. In this processing, if it is determined that a same-sliding-direction undercut portion that differs from the undercut portion whose slide mold surface has been acquired in the current first loop processing is included in the adjacent surface (Yes), the CPU 104 advances the processing to step S69. Meanwhile, if it is determined that a same-sliding-direction undercut portion that differs from the undercut portion whose slide mold surface has been acquired in the current first loop processing is not included in the adjacent surface (No), the CPU 104 advances the processing to step S67.

### Step S67

In step S67, the CPU 104 determines whether the adjacent surface acquired by the processing of step S65 is included within a range of movement of the slide mold when removing the slide mold arranged in the undercut portion whose slide mold surface has been acquired from the molded product. In this processing, at first, the CPU 104 reads the information of the sliding direction of the slide mold arranged in the undercut portion whose slide mold surface has been acquired from the data storage unit 103. Next, the CPU 104 computes a length from an upstream end position of the adjacent surface in the sliding direction being read to a position serving as a downstream end in the sliding direction of the molded product in the three-dimensional shape data. Then, the CPU 104 compares the computed length and a slide quantity computed by the processing of step S63, and determines whether the length is shorter than the slide quantity. As described, the CPU 104 determines whether the adjacent surface acquired by the processing of step S65 is included in a range of movement of the slide mold when removing the slide mold arranged in the undercut portion whose slide mold surface has been acquired from the molded product.

In step S67, if it is determined that the adjacent surface is included within the range in which the slide mold arranged in the undercut portion whose slide mold surface has been acquired moves (Yes), the CPU 104 advances the processing to step S68. Meanwhile, if it is determined that the adjacent surface is not included within the range in which the slide mold arranged in the undercut portion whose slide mold surface has been acquired moves (No), the CPU 104 determines that the adjacent surface acquired by the current second loop processing will not be added to the slide mold surface. Then, the CPU 104 returns the processing to step S65.

### Step S68

In step S68, the CPU 104 adds the adjacent surface acquired by the processing of step S65 to the slide mold surface acquired by the processing of step S62. By executing the processing of step S68, the CPU 104 may add the adjacent surface included in the range in which the slide mold arranged in the undercut portion whose slide mold surface has been acquired moves as the slide mold surface. After executing the processing of step S68, the CPU 104 returns the processing to step S65.

As described, the CPU 104 is configured to enable one adjacent surface to be added to the slide mold surface by a second loop processing performed once. In the processing of step S65 that is performed after the processing of steps S67 and S68, the CPU 104 acquires the surface that is adjacent to the adjacent surface added to the slide mold surface. By executing the second loop processing of steps S65 to S68, the CPU 104 is configured to enable a new adjacent surface to be added to the slide mold surface. The CPU 104 repeats the second loop processing until it is determined in the processing of step S66 that a same-sliding-direction undercut portion that differs from the undercut portion whose slide mold surface has been acquired in the current first loop processing is included.

The processing of steps S67 and S68 constitutes a processing of extracting an adjacent surface as a surface moldable by a single slide mold when the adjacent surface is included in the range in which the slide mold is moved in the sliding direction. Further, the second loop processing constitutes a processing of acquiring a second adjacent surface that is adjacent to a first adjacent surface, and a processing of extracting the second adjacent surface as a surface moldable by a single slide mold in a case where the second adjacent surface is included in the range in which the slide mold is moved in the sliding direction.

### Step S69

In the processing of step S69, the CPU 104 ends repeating the second loop processing performed for the same-sliding-direction undercut portions whose slide mold surface has been acquired by the processing of step S62 in the current first loop processing. The CPU 104 stores the result of the second loop processing in the data storage unit 103.

### Step S70

In step S70, the CPU 104 determines whether the slide mold surfaces of all the same-sliding-direction undercut portions have been acquired. In step S70, if it is determined that there is a same-sliding-direction undercut portion whose slide mold surface has not been acquired among the same-sliding-direction undercut portions (No), the CPU 104 returns the processing to step S62. Meanwhile, if it is determined that the slide mold surfaces have been acquired from all the same-sliding-direction undercut portions (Yes), the CPU 104 advances the processing to step S71.

As described, the CPU 104 acquires one same-sliding-direction undercut portion and an adjacent surface positioned within a range of movement of the slide mold arranged in the same-sliding-direction undercut portion as a slide mold surface by a single first loop processing. The CPU 104 repeats the first loop processing until it is determined that the processing of steps S62 to S69 have been executed for all the same-sliding-direction undercut portions.

### Step S71

In step S71, the CPU 104 ends repeating the first loop processing. The CPU 104 causes the data storage unit 103 to store the result of the first loop processing.

### Step S72

In step S72, the CPU 104 extracts a single slide mold surface. The CPU 104 extracts respective slide mold surfaces of a plurality of same-sliding-direction undercut portions acquired by repeating the first loop processing as single slide mold surfaces that are molded by one slide mold, i.e., single slide mold. In other words, if a different same-sliding-direction undercut portion is included in an adjacent surface of one same-sliding-direction undercut portion, the CPU 104 extracts the surface as a single slide mold surface moldable by a single slide mold.

The information of the single slide mold surface being extracted is stored in the data storage unit 103 by the CPU 104. Moreover, the CPU 104 displays the surface being extracted as a single slide mold surface on the display unit 102. In other words, the CPU 104 displays the surfaces to be molded by the same slide mold on the display unit 102 in the processing of step S72.

Thereby, the information processing apparatus 100 may enable the operator to visually recognized which surfaces of the three-dimensional shape of the molded product are set as the single slide mold surface, and the operator is enabled to easily distinguish the single slide mold surface.

The details of the processing of steps S61 to S72 will be described in detail with reference to FIGS. 19A, 19B, 22A, 22B, and 23A to 23C. At first, a case in which the CPU 104 executes the processing of steps S61 to S72 to the molded product having the three-dimensional shape data 400 illustrated in FIGS. 19A and 19B will be described.

In the processing of step S62, the CPU 104 acquires a surface at which the undercut portion 408a adjoins the hole 401A as a slide mold surface. Next, the CPU 104 computes a slide quantity of the slide mold arranged in the undercut portion 408a in the processing of step S63. As illustrated in FIG. 19B, the CPU 104 computes the slide quantity ST1A of the slide mold arranged in the undercut portion 408a.

The CPU 104 starts the second loop processing of steps S64 to S68, and in the processing of step S65, acquires an adjacent surface 401 of the undercut portion 408a as the adjacent surface. In the processing of step S66, the CPU 104 determines that the undercut portion 408b is included in the surface 401, and advances the processing from step S66 to step S69.

The CPU 104 advances the processing from step S69 to step S70, determines that the slide mold surface of the undercut portion 408b has not been acquired in step S70, and returns the processing to step S62.

In the processing of step S62 during the first loop processing performed for the second time, the CPU 104 acquires a surface at which the undercut portion 408b adjoins the wall portions 406 and 407 and a range of the surface 401 sandwiched between the wall portions 406 and 407 as the slide mold surface. Next, in the processing of step S63, the CPU 104 computes a slide quantity in the sliding direction SL1D of the slide mold arranged in the undercut portion 408b. As illustrated in FIG. 19B, the CPU 104 computes the slide quantity ST1B in the sliding direction SL1D of the slide mold arranged in the undercut portion 408b.

The CPU 104 starts the second loop processing of steps S64 to S68, and in the processing of step S65, acquires the surface 401 adjacent to the undercut portion 408b as the adjacent surface. In the processing of step S66, the CPU 104 determines that the undercut portion 408a is included in the surface 401, and advances the processing from step S66 to step S69.

The CPU 104 advances the processing from step S69 to step S70, and in step S70, determines that the slide mold surfaces have been acquired from the undercut portions 408a and 408b, and advances the processing to step S71. Then, in the processing of step S72, the CPU 104 sets the slide mold arranged in the undercut portion 408a and the slide mold arranged in the undercut portion 408b as a single slide mold. Further, the CPU 104 extracts the slide mold surface by the slide mold arranged in the undercut portion 408a and the slide mold surface by the slide mold arranged in the undercut portion 408b as single slide mold surfaces.

By forming a plurality of undercut portions using a single slide mold, the information processing apparatus 100 may suppress the increase in the number of slide molds and downsize the mold used to form the molded product, according to which the manufacturing cost of the mold can be suppressed.

The undercut portions 408a and 408b constitute at least two undercut portions being extracted by the extraction processing, wherein the undercut portion 408a constitutes a first undercut portion and the undercut portion 408b constitutes a second undercut portion. Further, the surface 401 constitutes the adjacent surface.

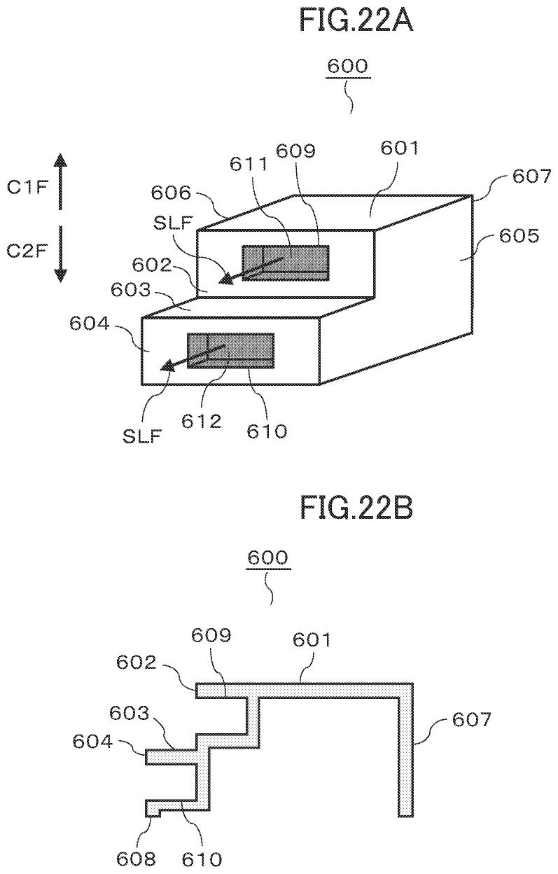

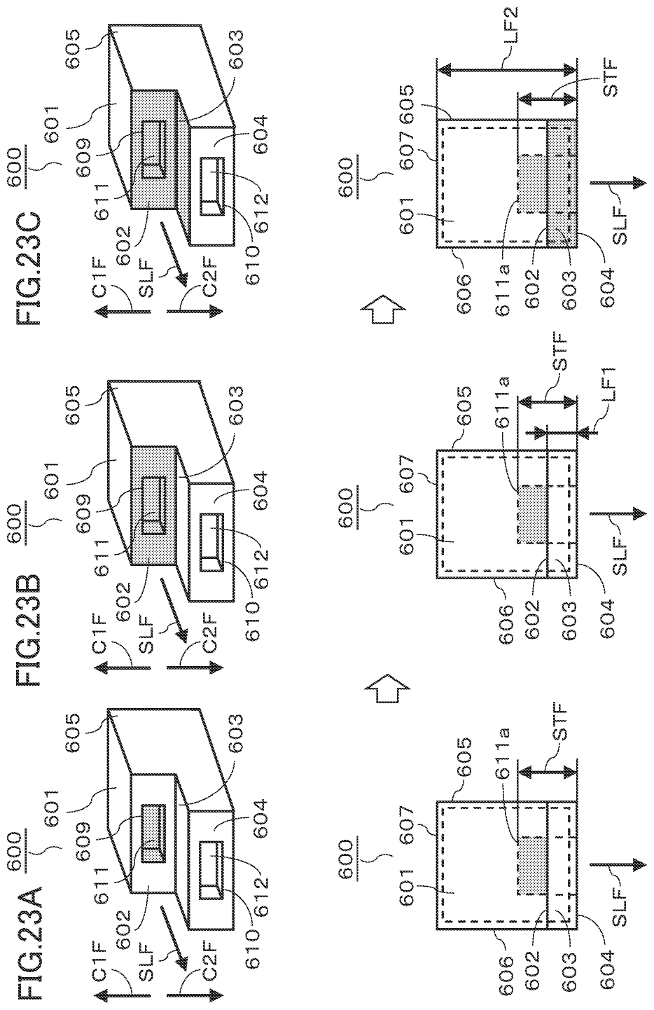

Next, the processing of steps S61 to S72 is described specifically with reference to FIGS. 22A to 23C. FIG. 22A is a perspective view illustrating a three-dimensional shape data 600 of the molded product to specifically illustrate the processing of steps S61 to S72, and FIG. 22B is a cross-sectional view of the three-dimensional shape data 600. Further, FIG. 23A is a schematic diagram illustrating a processing of steps S62 and S63 illustrated in FIG. 21, and FIG. 23B is a schematic diagram illustrating a processing of a case where the adjacent surface is added to the slide mold surface in the processing of steps S65 to S68. Further, FIG. 23C is a schematic diagram illustrating a case where the adjacent surface is not added to the slide mold surface in the processing of steps S65 to S67.

As illustrated in FIGS. 22A and 22B, the three-dimensional shape data 600 is a shape surrounded by surfaces 601 to 607, wherein a surface 608 is formed by the thickness of surfaces 604 to 607, and wherein the mold opening directions of the cavity mold and the core mold are set to mold opening directions C1F and C2F. A recess portion 609 is formed on the surface 602, and a recess portion 610 is formed on the surface 604. In the three-dimensional shape data 600, respective spaces surrounded by recess portions 609 and 610 in the mold opening directions C1F and C2F are undercut portions 611 and 612. A slide mold arranged in the undercut portion 611 and a slide mold arranged in the undercut portion 612 may each be removed from the molded product by sliding in a sliding direction SLF, and they constitute a plurality of same-sliding-direction undercut portions.

In the processing of step S62, the CPU 104 acquires the surface in which the undercut portion 611 adjoins the recess portion 609 as the slide mold surface. Next, in the processing of step S63, the CPU 104 computes a slide quantity of a slide mold arranged in the undercut portion 611. As illustrated in FIG. 23A, the CPU 104 computes a range from an end portion 611a of the undercut portion 611 upstream in the sliding direction SLF to the surface 604 of the three-dimensional shape data 600 downstream in the sliding direction SLF as a slide quantity STF.

The CPU 104 starts the second loop processing of steps S64 to S68, and in the processing of step S65, acquires a surface 602 adjacent to the undercut portion 611 as an adjacent surface. In the processing of step S66, the CPU 104 determines that there the surface 602 does not include the undercut portion 612, and advances the processing to step S67. In the processing of step S67, the CPU 104 computes the upstream end position of the surface 602 in the sliding direction SLF and the distance LF1 to the surface 604 in the sliding direction SLF. As illustrated in FIG. 23B, the distance LF1 is shorter than the slide quantity STF. Therefore, the CPU 104 determines that the surface 602 is included in the range of movement of the slide mold when removing the slide mold arranged in the undercut portion 611 from the molded product, and advances the processing to step S68.

The CPU 104 executes the processing of step S68, adds the surface 602 to the slide mold surface, and returns the processing to step S65. As illustrated in FIG. 23C, the surface 602 is adjacent to surfaces 601, 603, 605, and 606. As for surfaces 601, 605, and 606, the distance from the upstream end to the surface 604 in the sliding direction SLF is a distance LF2 that is longer than the slide quantity STF. Therefore, the CPU 104 returns the processing to step S65 without adding the surfaces 601, 605, and 606 to the slide mold surface. Meanwhile, as for the surface 603, the distance from the upstream end to the surface 604 in the sliding direction SLF is the distance LF1. Therefore, the CPU 104 adds the surface 603 to the slide mold surface in the processing of step S68, and returns the processing to step S65.

After finishing the second loop processing to surfaces 601, 603, 605, and 606, the CPU 104 acquires the surface 604 in the processing of step S65. As illustrated in FIGS. 23A to 23C, the undercut portion 612 which is the same-sliding-direction undercut portion that differs from the undercut portion 611 is adjacent to the surface 604. Therefore, the CPU 104 advances the processing from step S66 to step S69.

The CPU 104 advances the processing from step S69 to step S70, determines that the slide mold surface of the undercut portion 612 has not been acquired in step S70, and returns the processing to step S62.

In the processing of step S62 in the first loop processing performed for the second time, the CPU 104 acquires the surface in which the undercut portion 612 adjoins the recess portion 610 as the slide mold surface. The CPU 104 adds the surface 604 to the slide mold surface by executing the second loop processing, and does not add surfaces 605 to 608 that are adjacent to the surface 604 to the slide mold surface. Further, by executing the second loop processing, the CPU 104 adds the surface 603 adjacent to the surface 604 to the slide mold surface. Then, the CPU 104 advances the processing from step S66 to step S69 since the undercut portion 611 is adjacent to the surface 602 that is adjacent to the surface 603.

The CPU 104 advances the processing from step S69 to S70, and in step S70, determines that the slide mold surfaces have been acquired from the undercut portions 611 and 612, before advancing the processing to step S71. Then, in the processing of step S72, the CPU 104 sets the slide mold arranged in the undercut portion 611 and the slide mold arranged in the undercut portion 612 as a single slide mold. Further, the CPU 104 extracts the slide mold surfaces formed by the slide mold arranged in the undercut portion 611 and the slide mold surfaces formed by the slide mold arranged in the undercut portion 612 as single slide mold surfaces.

By executing the processing of steps S61 to S72, the information processing apparatus 100 may extract, in addition to the surfaces at which the undercut portions 611 and 612 adjoin the three-dimensional shape data 600, the adjacent surfaces 602 to 604 as single slide mold surfaces.

By forming a plurality of surfaces of the molded product using one slide mold, the information processing apparatus 100 may suppress the increase of the number of slide molds, downsize the mold for forming the molded product, and suppress the manufacturing costs of the mold.

The undercut portions 611 and 612 constitute at least two undercut portions extracted by the extraction processing, wherein the undercut portion 611 constitutes a first undercut portion, and the undercut portion 612 constitutes a second undercut portion. Further, the respective surfaces constituting the recess portion 609 constitutes a first undercut surface, and the respective surfaces constituting the recess portion 610 constitutes a second undercut surface. The surfaces 602 to 604 constitute adjacent surfaces and a non-undercut surface, wherein the surface 602 constitutes a first adjacent surface, and the surface 603 constitutes a second adjacent surface. Information Processing Method of step S36 and thereafter

After executing the processing of step S36 described above, the CPU 104 advances the processing to step S37.

### Step S37

In step S37, the CPU 104 creates a parting line for each of the boundary between the cavity mold surface and the core mold surface, the boundary between the cavity mold surface and the slide mold surface, and the boundary between the core mold surface and the slide mold surface. The CPU 104 reads the three-dimensional shape data of the molded product, the information of the cavity mold surface, the information of the core mold surface, and the information of the slide mold surface from the data storage unit 103. The CPU 104 also reads the information of the single slide mold surface as information of the slide mold surface from the data storage unit 103.

Thereby, the CPU 104 may arrange a single slide mold in the plurality of undercut portions that is non-moldable by the cavity mold and the core mold, and may form single slide mold surfaces using the single slide mold. The created parting line information is stored in the data storage unit 103 by the CPU 104. In some cases, the CPU 104 may store the created parting line information through the communication unit 107 to an external storage device or send the information to an external computer.

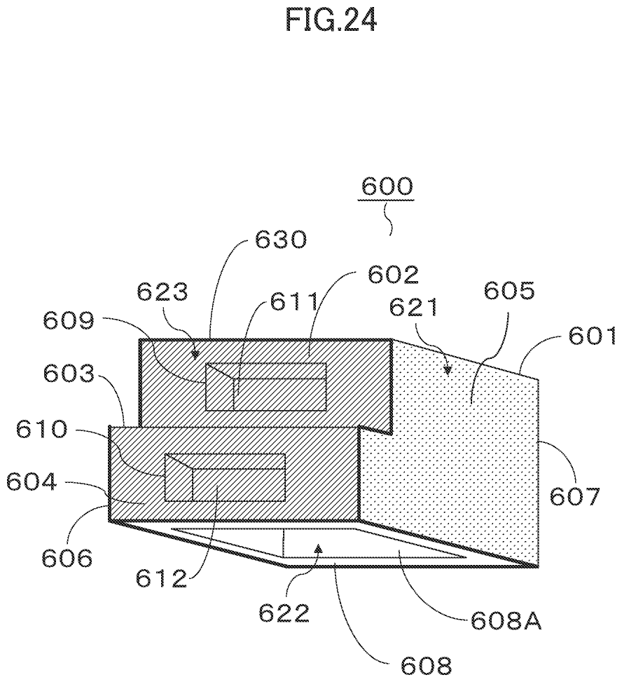

FIG. 24 is a perspective view illustrating the three-dimensional shape data 600 of the molded product for describing the processing of step S37. As illustrated in FIG. 24, the CPU 104 acquires surfaces 601 and 605 to 607 of the three-dimensional shape data 600 as cavity mold surfaces 621. Further, the CPU 104 acquires the surface 608 of the three-dimensional shape data 600 and respective surfaces surrounded by a hole 608A having the quadrangular hole shape formed on the surface 608 as core mold surfaces 622. Further, the CPU 104 acquires single slide mold surfaces 623 that have been extracted by the processing of step S36. Then, the CPU 104 creates a parting line 630 on the boundary line serving as boundaries for each of the cavity mold surface 621, the core mold surface 622, and the single slide mold surface 623.

As described, the information processing apparatus 100 according to the present embodiment enables to efficiently create parting lines while considering the single slide mold surfaces. Thereby, the information processing apparatus 100 may guarantee a formability of the mold for molding the molded product, and may suppress the occurrence of reworking such as the redesigning of the shape of the molded product that has been designed by a product designer.

### Step S38

In step S38, the CPU 104 designs the shape of the molds. The CPU 104 reads the parting line information created by the processing of step S37 from the data storage unit 103. The CPU 104 creates shape data of each of the cavity mold, the core mold, and the slide mold from the parting line information being read. The shape data of each of the cavity mold, the core mold, and the slide mold being created is stored in the data storage unit 103 by the CPU 104. In some cases, the CPU 104 may store the shape data of each of the cavity mold, the core mold, and the slide mold being created through the communication unit 107 in an external storage device, or may send the same to an external computer.

The processing of steps S37 and S38 constitute a processing of generating a parting line of the cavity mold, the core mold, and the slide mold, and generates a shape data of the cavity mold, the core mold, and the slide mold using the molded product information and the parting line information.

### Summary of Present Embodiment

As described, the information processing apparatus 100 according to the present embodiment extracts a plurality of same-sliding-direction undercut portions in which a single slide mold is arranged from among the plurality of undercut portions. The information processing apparatus 100 may suppress the number of components of the mold and simplify the structure by adopting a common slide mold to be arranged in the plurality of undercut portions. Thereby, the information processing apparatus 100 may cut down costs related to the mold, such as the manufacturing costs of the mold or the design costs of the mold including design change costs for a more efficient mold or check costs for confirming the change of design. Further, the information processing apparatus 100 may reduce shipping costs and maintenance costs of the mold as the costs related to the mold. Moreover, the information processing apparatus 100 may reduce manufacturing costs of the molded produce by cutting down energy for moving the mold as the costs related to the mold. Further, the extracted single slide mold may be utilized for designing the mold. This type of information processing method may be applied not only to the designing of the mold but to the checking and inspection of data of the mold being designed or manufactured, and to the presentation of the mold being designed or manufactured.

### Modified Example

The present invention is not limited to the embodiments and examples described above, and various modifications are enabled within the technical concept of the invention.

Further, according to the present embodiment, a case has been described where the cavity mold, i.e., stationary mold, and the core mold, i.e., movable mold, are set in advance before creating the parting lines, but the present invention is not limited thereto. That is, in the stage of creating a parting line of two molds, i.e., the first mold and the second mold, it is not necessary to determine which of the two molds is the core mold and which is the cavity mold. It may be possible to set the cavity mold and the core mold after creating the parting line, or to temporarily set the cavity mold and the core mold before creating the parting line, and then determine the setting of the cavity mold and the core mold after creating the parting line.

Even further according to the present embodiment, a case has been described of a molded product with a three-dimensional shape where two portions serve as undercut portions when opening the cavity mold and the core mold, but the present technique is not limited thereto. The molded product should merely include at least two undercut portions in which a single slide mold is arranged, and it may also have a single slide mold arranged in three or more undercut portions.

According even further to the present embodiment, the CPU 104 is configured to display the surface where the plurality of same-sliding-direction undercut portions being extracted in the processing of step S54 and the three-dimensional shape data of the molded product adjoin on the display unit 102, but the present technique is not limited thereto. The CPU 104 may be configured to display the plurality of same-sliding-direction undercut portions being extracted on the display unit 102 in the image illustrating the three-dimensional space. That is, the CPU 104 may be configured to display the range of the plurality of same-sliding-direction undercut portions being extracted on the display unit 102.

According to this configuration, the CPU 104 may be configured to display the image illustrating the boundary line or the boundary surface serving as the boundary between the three-dimensional space illustrating the same-sliding-direction undercut portion and the non-molded product spacing enclosing the molded product on the display unit 102.

A program capable of executing the information processing described above and a computer-readable storage medium storing the program are also included in the embodiments of the present technique. Further, a mold designing method using the information processing described above is also included in the embodiments of the present technique. Furthermore, a manufacturing method of a mold manufactured by the information processing described above and a manufacturing method of a molded product for manufacturing the molded product using the mold manufactured by the manufacturing method are also included in the embodiments of the present technique.

The present technique may be realized by supplying a program for realizing one or more functions of the present embodiment via a network or a storage medium to a system or an apparatus, and having one or more processors of a computer of the system or the apparatus read and execute the program. Further, the present technique may be realized by a circuit, such as an ASIC, that realizes the one or more functions.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-182673, filed Nov. 15, 2022, and Japanese Patent Application No. 2022-182674, filed Nov. 15, 2022, which are hereby incorporated by reference herein in their entirety.

What is claimed is:

1. An information processing method of designing a mold for molding a molded product, the method comprising:
a processing of receiving data including a molded product area indicating a three-dimensional shape of the molded product, and a non-molded product area indicating a three-dimensional shape of a non-molded product space enclosing the molded product; and
a processing of extracting, from the non-molded product area, a three-dimensional space that becomes an undercut portion in a state where a first mold and a second mold forming the molded product are opened.

2. The information processing method according to claim 1, further comprising a processing of displaying the three-dimensional space on a display unit.

3. The information processing method according to claim 2, wherein further comprising a processing of displaying a boundary line or a boundary surface serving as a boundary between a space within the non-molded product area that does not constitute an undercut portion when opening the mold and the three-dimensional space.

4. The information processing method according to claim 1, further comprising an information setting processing of setting an undercut information regarding a range of the non-molded product area sandwiched by the molded product area in a first direction corresponding to a direction of opening of the mold.

5. The information processing method according to claim 4, further comprising a processing of setting, in a state where the undercut information is set in the first direction and the undercut information is not set in a second direction that differs from the first direction, the second direction as a sliding direction of a third mold arranged in the undercut portion.

6. The information processing method according to claim 5,
wherein the undercut portion is one of a plurality of undercut portions each of the plurality of undercut portions adjoining one another, and
wherein the information processing method further comprises a processing of setting the plurality of undercut portions as an integrated undercut portion in a case where a same direction has been set as the sliding direction of the third mold for forming each of the plurality of undercut portions.

7. The information processing method according to claim 5, wherein, in a case where there are a plurality of directions that can be set as the first direction, a direction where a variety of the sliding direction in opening the first mold and the second mold become smallest among the plurality of the directions is set as the first direction.

8. The information processing method according to claim 4, wherein a portion where the non-molded product area having the undercut information set in the first direction adjoin the molded product area is set as an undercut portion in the first direction.

9. The information processing method according to claim 4, further comprising
a processing of dividing the non-molded product area into evenly spaced three-dimensional spaces, and
wherein in the information setting processing, the undercut information is set for each three-dimensional space being divided.

10. The information processing method according to claim 4, further comprising
a processing of generating evenly spaced points in the non-molded product area, and
wherein in the information setting processing, the undercut information is set for each point.

11. The information processing method according to claim 4, further comprising
setting a boundary portion of switching from the molded product area to the non-molded product area in a direction opposed to the first direction, and
wherein in the information setting processing, the undercut information is set for the non-molded product area upstream in the first direction of the boundary portion.

12. The information processing method according to claim 4,
wherein the information setting processing includes
acquiring a first length from a downstream end of the non-molded product area in the first direction to a first boundary portion where the molded product area switches to the non-molded product area in the first direction, and a second length from the downstream end to a second boundary portion where the molded product area switches to the non-molded product area in a direction opposed to the first direction, and
setting the undercut information of a range sandwiched between the first boundary portion and the second boundary portion in a case where the first length is shorter than the second length.

13. The information processing method according to claim 1, further comprising
creating a parting line between the first mold and the second mold, and creating a shape data of the first mold and the second mold using information of the molded product area and the parting line.

14. An information processing method comprising:
a processing of extracting a plurality of undercut portions becoming an undercut when opening a first mold and a second mold to form a molded product;
a processing of setting, for each of the plurality of undercut portions, a sliding direction of a slide mold arranged in the undercut portion;
a processing of extracting, among the plurality of undercut portions, at least two undercut portions in which a single slide mold is arranged; and
a processing of extracting a surface that may be molded by the single slide mold and that includes an area that does not adjoin any one of the plurality of undercut portions.

15. The information processing method according to claim 14, further comprising a processing of determining, among the plurality of undercut portions, at least two undercut portions whose sliding direction is set to a same direction as having the single slide mold arranged therein.

16. The information processing method according to claim 14, further comprising a processing of displaying a range molded by the single slide mold on a display unit.

17. The information processing method according to claim 14, further comprising a processing of displaying a portion where at least one of the two undercut portions adjoin the molded product on a display unit.

18. The information processing method according to claim 14, further comprising a processing of displaying a three-dimensional space of at least one of the two undercut portions on a display unit.

19. The information processing method according to claim 14, wherein the extraction processing includes extracting a first undercut portion and a second undercut portion as at least two undercut portions in which the single slide mold is arranged, and extracting, among the molded product, a first undercut surface adjoining the first undercut portion, a second undercut surface adjoining the second undercut portion, and a non-undercut surface that is adjacent to at least one of the first undercut surface and the second undercut surface and that does not adjoin any one of the plurality of undercut portions as surfaces that may be molded by the single slide mold.

20. The information processing method according to claim 14, further comprising
a processing of acquiring a range in which the slide mold moves in the sliding direction,
a processing of acquiring an adjacent surface that is adjacent to at least one of the two undercut portions, and
in a case where the adjacent surface is included in the range, a processing of extracting the adjacent surface as a surface that may be molded by the single slide mold.

21. The information processing method according to claim 20, further comprising
in a case where a first adjacent surface serving as the adjacent surface is included in the range, a processing of acquiring a second adjacent surface that is adjacent to the first adjacent surface, and
in a case where the second adjacent surface is included in the range, a processing of extracting the second adjacent surface as a surface that may be molded by the single slide mold.

22. The information processing method according to claim 14, further comprising, in a case where there are a plurality of candidates of the sliding direction of the slide mold, a processing of setting a direction in which an amount of movement when removing the slide mold from the molded product is smallest as the sliding direction.

23. The information processing method according to claim 14, further comprising generating a parting line of the first mold, the second mold, and the slide mold, and by using an information of the molded product and an information of the parting line, generating a shape data of the first mold, the second mold, and the slide mold.

24. A computer-readable storage medium storing a program of executing the information processing method according to claim 1 by an information processing unit.

25. An information processing apparatus comprising an information processing unit configured to execute the information processing method according to claim 1.

26. A designing method of a mold using the information processing method according to claim 1.

27. A manufacturing method of a mold, comprising manufacturing a mold based on shape data of the first mold and the second mold created by the designing method of a mold according to claim 26.

28. A manufacturing method of a molded product, comprising manufacturing a molded product using a mold manufactured by the manufacturing method according to claim 27.
